(19) United States
(12) Patent Application Publication
(10) Pub. No.: US 2026/0341149 A1
(43) Pub. Date: Oct. 29, 2026

(54) SYSTEM AND METHOD FOR TRAFFIC INCIDENT DETECTION USING UNMANNED AERIAL VEHICLE

(71) Applicant: UNIVERSITY OF SOUTH FLORIDA, Tampa, FL (US)

(72) Inventors: Bai LI, Tampa, FL (US); Yu Yu April ZHANG, Tampa, FL (US)

(21) Appl. No.: 19/663,180

(22) Filed: Apr. 29, 2026

Related U.S. Application Data
(60) Provisional application No. 63/796,508, filed on Apr. 29, 2025.

(51) Int. Cl. G08G 1/01; G06V 20/17; G06V 20/54; G08G 1/056

(52) U.S. Cl. CPC G08G 1/0133; G06V 20/17; G06V 20/54; G08G 1/0112; G08G 1/0145; G08G 1/056; G06V 2201/08

(57) ABSTRACT

Examples relate to classifying a traffic state represented in an input trajectory image as one of a plurality of traffic condition classes is achieved by performing a plurality of sequentially executed feature extraction stages. Each stage applies convolutional kernels, generates weights, and scales channels to produce a channel-weighted feature map. A spatial weight map is generated and multiplied by the channel-weighted feature map to produce a spatially-weighted feature map. Pooling operations are applied at different spatial resolutions and the resulting pooled values are combined into a vector. The vector is passed through fully connected layers to produce a traffic state classification. The classification can be used to detect traffic incidents, extract incident features, and provide real-time traffic monitoring and incident detection.

### CROSS-REFERENCE TO RELATED APPLICATIONS

This Application claims priority to U.S. Provisional Patent Application No. 63/796,508, filed on Apr. 29, 2025, entitled “DARTS: A Drone-Based AI-Powered Real-Time Traffic Incident Detection System” the entire disclosure of which is incorporated herein by reference.

### STATEMENT OF GOVERNMENT SUPPORT

This invention was made with government support under 69A3551947136 awarded by the Department of Transportation. The government has certain rights in the invention.

### TECHNICAL FIELD

The present disclosure relates to traffic monitoring and incident detection, and more specifically, to unmanned aerial vehicle (UAV)-based traffic monitoring and incident detection.

### BACKGROUND

Traffic incidents, including vehicle collisions and roadway obstructions, are a leading cause of non-recurrent congestion on freeways. According to the Federal Highway Administration (FHWA), traffic incidents are the primary source of non-recurrent congestion, contributing to extensive transportation delays, excessive energy consumption, and associated environmental pollution. Beyond an impact on traffic flow, traffic incidents result in fatalities, injuries, and secondary crashes. Prompt emergency response following a traffic crash is important, as even brief delays in emergency medical services can significantly increase crash mortality rates. Accordingly, timely and accurate detection and verification of traffic incidents, combined with immediate access to on-site information for dispatching emergency responders, is essential for reducing the number of severe injuries and fatalities caused by traffic incidents.

Transportation Management Centers (TMCs) are responsible for monitoring freeway traffic conditions and coordinating incident response. When a traffic incident is detected, TMCs must rapidly assess the type and severity of the incident and dispatch appropriate emergency response resources. The ability of TMCs to promptly obtain accurate information about the impact of incidents on upstream and downstream traffic flows enables timely decisions such as rerouting, adjusting traffic signals, or closing sections of the road, thereby mitigating the spread of non-recurrent congestion and facilitating the rapid restoration of traffic flow.

Conventional traffic incident detection methods can be categorized into sensor-based and video-based approaches. Sensor-based methods rely on fixed infrastructure such as inductive loop detectors, magnetometers, microwave radar, and floating vehicles equipped with on-board GPS devices to collect traffic data. While these methods can detect changes in traffic flow parameters indicative of an incident, these methods require high-density deployment of sensors and vehicles to achieve accurate detection, and cannot provide an on-site scene view for verifying the incident or accurately evaluating its severity. Additionally, the changes in traffic patterns caused by incidents often take time to propagate upstream, making it challenging to detect incidents promptly and to assess impact range accurately.

Video-based methods leverage closed-circuit television (CCTV) surveillance cameras and, more recently, dashcam footage from floating vehicles, in conjunction with machine learning and deep learning models, to analyze video data for automatic traffic incident detection. While cameras allow visual assessment of incident severity, accurate incident detection still relies on high-density deployment of CCTV cameras with well-refined observing angles, or a sufficient penetration rate of floating vehicles equipped with dashcams. Furthermore, these detection methods lack an accurate and efficient approach to determining the impact range of an incident and the resulting propagation of congestion.

Visible-light RGB cameras used in CCTV systems and floating vehicles also perform poorly under low-visibility conditions such as nighttime and foggy weather, and may inadvertently capture sensitive personal information such as license plates or driver faces, raising privacy concerns. Drone or unmanned aerial vehicle (UAV) technology has emerged as a promising platform for intelligent traffic monitoring. However, existing drone-based approaches for traffic incident management primarily emphasize post-incident investigation and analysis, such as three-dimensional reconstruction of accident scenes, rather than real-time incident detection.

### SUMMARY

Various examples of the described technology may provide a traffic incident detection system that achieves timely and accurate real-time detection of freeway traffic incidents, enables simultaneous online visual verification and severity assessment, accurately evaluates the impact range and propagation speed of incident-induced non-recurrent congestion, and operates effectively under low-visibility conditions while preserving privacy.

Other aspects will become apparent by consideration of the detailed description and accompanying drawings.

When compared to conventional approaches described herein in which traffic incident detection relies on fixed sensor infrastructure or stationary CCTV cameras that require dense deployment, are limited to fixed coverage areas, and cannot provide real-time on-site visual verification, with the disclosed techniques, a drone-based, AI-powered real-time traffic incident detection system integrates the high mobility and aerial perspective of drones, the robustness of thermal cameras under low-visibility conditions, and a lightweight deep learning framework to enable continuous freeway patrol, real-time incident detection, and immediate online visual verification. In that regard, at least one technical advantage of the disclosed techniques relative to conventional approaches is that, with the disclosed techniques, traffic incidents can be detected and verified earlier than by conventional TMC methods, thereby enabling faster emergency response and potentially reducing fatalities and serious injuries caused by delayed medical assistance. At least another technical advantage of the disclosed techniques relative to conventional approaches is that, with the disclosed techniques, the system can automatically calculate and display the length and propagation speed of incident-induced non-recurrent congestion across consecutive detection flights, providing TMCs with actionable data for proactive traffic management. In that regard, because the disclosed techniques allow for simultaneous real-time incident detection, online visual verification, and congestion propagation monitoring via a web-based graphical user interface (GUI), the risk of delayed incident response and secondary crashes caused by undetected or unverified incidents is reduced.

### BRIEF DESCRIPTION OF THE DRAWINGS

FIG. 1 illustrates an example system for incident detection, according to the present teachings.

FIG. 2 illustrates an example system architecture for UAV-based incident detection, according to the present teachings.

FIG. 3A illustrates an example method for generating vehicle trajectory images, according to the present teachings.

FIG. 3B illustrates an example visualization of the trajectory image generation performed using the method.

FIG. 4 illustrates an example TCD-Net architecture that may be implemented in conjunction with the system of FIG. 1, according to the present teachings.

FIG. 5 illustrates example loss and accuracy curves associated with a training and testing of the TCD-Net architecture described with reference to FIG. 4.

FIG. 6A illustrates an example video live streaming process.

FIG. 6B illustrates an example control process for performing traffic incident detection with respect to a live stream of video data, according to the present teachings.

FIG. 6C illustrates an example process for receiving position information associated with the drone, according to the present teachings.

FIG. 6D illustrates an example process for performing incident detection, according to the present teachings.

FIG. 7 illustrates an example software architecture for a traffic incident detection platform, according to the present teachings.

FIGS. 8A-8C illustrate example GUIs for drone control in a traffic incident detection system, according to the present teachings.

FIGS. 9A-9B illustrate example webpage GUIs for reviewing incident detection and traffic history in a traffic incident detection platform, according to the present teachings.

FIGS. 10A-10B illustrate example mobile device GUIs for reviewing incident detection and traffic history in a traffic incident detection platform, according to the present teachings.

FIGS. 11A-11D illustrate example GUIs displaying traffic incident detection results from three example detection flights, according to the present teachings.

FIG. 12 is a block diagram of a system workstation that may be implemented in conjunction with the computing system of FIG. 1, according to present teachings.

FIG. 13 illustrates an example process for training a machine learning model implemented in conjunction with the system of FIG. 1, according to the present teachings.

FIG. 14 is a flow diagram of a process for UAV-based traffic incident detection, according to the present teachings.

Skilled artisans will appreciate that elements in the figures are illustrated for simplicity and clarity and have not necessarily been drawn to scale. For example, the dimensions of some of the elements in the figures may be exaggerated relative to other elements to help improve understanding of examples of the present disclosure.

The system, apparatus, and method components have been represented where appropriate by conventional symbols in the drawings, showing details that are pertinent to understanding the examples of the present disclosure so as not to obscure the disclosure with details that will be readily apparent to those of ordinary skill in the art having the benefit of the description herein.

### DETAILED DESCRIPTION

Examples are herein described with reference to flowchart illustrations and/or block diagrams of methods, apparatus (systems) and computer program products according to examples. It will be understood that each block of the flowchart illustrations and/or block diagrams, and combinations of blocks in the flowchart illustrations and/or block diagrams, can be implemented by computer program instructions. These computer program instructions may be provided to a processor of a special purpose computer, special purpose computer, or other programmable data processing apparatus to produce a special purpose and unique machine, such that the instructions, which execute via the processor of the computer or other programmable data processing apparatus, create means for implementing the functions/acts specified in the flowchart and/or block diagram block or blocks. The methods and processes set forth herein need not, in some examples, be performed in the exact sequence as shown and likewise various blocks may be performed in parallel rather than in sequence.

These computer program instructions may also be stored in a computer-readable memory that can direct a computer or other programmable data processing apparatus to function in a particular manner, such that the instructions stored in the computer-readable memory produce an article of manufacture including instructions which implement the function/act specified in the flowchart and/or block diagram block or blocks.

The computer program instructions may also be loaded onto a computer or other programmable data processing apparatus that may be on or off-premises, or may be accessed via the cloud in any of a software as a service (SaaS), platform as a service (PaaS), or infrastructure as a service (IaaS) architecture so as to cause a series of operational blocks to be performed on the computer or other programmable apparatus to produce a computer implemented process such that the instructions which execute on the computer or other programmable apparatus provide blocks for implementing the functions/acts specified in the flowchart and/or block diagram block or blocks. It is contemplated that any part of any aspect or example discussed in this specification can be implemented or combined with any part of any other aspect or example discussed in this specification.

Further advantages and features consistent with this disclosure will be set forth in the following detailed description, with reference to the figures.

As used throughout this disclosure, the terms “module,” “component,” “unit,” “framework,” “platform,” “system,” “engine,” “device,” and similar terms, when used to describe elements of the disclosed systems and methods, each denote specific structural implementations and are not intended to recite purely functional limitations. Each such term refers to a defined combination of hardware, software executing on one or more processors, data structures, and/or electronic circuitry, as described in detail herein. Specifically, each module, component, unit, framework, platform, or system described herein is implemented as one or more of: (a) a specific hardware circuit or hardware component, such as an application-specific integrated circuit (ASIC), a field-programmable gate array (FPGA), a graphics processing unit (GPU), a central processing unit (CPU), a digital signal processor (DSP), or a dedicated microcontroller; (b) specific software instructions, routines, algorithms, or program code stored in a non-transitory computer-readable medium and executed by one or more processors to perform the functions described herein; or (c) a specific combination of hardware and software, in which software instructions configure a general-purpose or special-purpose processor to operate as a special-purpose computing device that performs the functions described herein. The structural implementations of each such term are set forth in the detailed descriptions that follow, including the specific algorithms, data flows, data structures, processor configurations, memory architectures, and inter-component interfaces associated with each element. Persons of ordinary skill in the art, upon reading this specification, will recognize each such term as denoting the specific structure described herein, rather than as a generic placeholder for any structure that performs the recited function.

Without limitation, the following structural implementations apply to the named components described herein. The system workstation 116 is a computing device comprising at least one processor 1204 (e.g., an Intel Core i7 or i9 series CPU, an AMD Ryzen series CPU, or a comparable multi-core processor), at least one GPU (e.g., an NVIDIA GeForce RTX 3080 GPU or a comparable GPU having CUDA cores and dedicated video memory), system memory 1220 (e.g., DDR4 or DDR5 random access memory (RAM) having a capacity of at least 16 gigabytes), a system disk 1224 (e.g., a solid-state drive (SSD) or hard disk drive (HDD)), a network interface 1216 (e.g., an Ethernet network interface card (NIC) or a Wi-Fi adapter), and an interconnect 1228 (e.g., a PCIe bus, a system bus, or a combination thereof) coupling the foregoing components. The drone 104 is an unmanned aerial vehicle comprising a flight controller (e.g., a DJI A3 or N3 flight controller or a comparable autopilot module), one or more electric motors coupled to rotors, an inertial measurement unit (IMU), a GPS receiver, at least one imaging device (e.g., a DJI Zenmuse XT2 thermal camera, a FLIR Vue Pro thermal camera, a visible-light RGB camera, or a dual-mode camera), an onboard communication transceiver (e.g., a 2.4 GHz or 5.8 GHz radio transceiver such as a DJI Lightbridge or OcuSync transceiver), and a battery power supply. The first remote controller 108 is a ground control computing device comprising a processor, a display, a wireless transceiver compatible with the drone communication protocol (e.g., a DJI Smart Controller or a tablet computer running DJI Pilot or a comparable ground control application), and input controls for transmitting flight commands and mission plans to the drone 104. The second remote controller 112 is a live deck or drone information-receiving device comprising a processor, a wireless transceiver for receiving video and telemetry data from the drone 104, a cellular modem (e.g., a 4G LTE or 5G modem) for transmitting data to the system workstation 116 and the livestream platform 120, and a software application (e.g., a native Android application) executing on the processor to manage data routing between the drone 104, the system workstation 116, and the livestream platform 120. The livestream platform 120 is one or more backend servers or a distributed cloud-based streaming service (e.g., an RTMP-based streaming server, a YouTube Live server, or a comparable real-time video streaming infrastructure) comprising one or more server processors, server memory, network interfaces, and streaming software configured to receive, transcode, host, and distribute live video data streams.

The data collection module 204 is a software routine or set of software routines stored in the system memory 1220 of the system workstation 116 and executed by the processor 1204, the routines comprising instructions for interfacing with the drone 104 and the second remote controller 112 to receive thermal video data and GPS coordinate data, and for storing the received data in designated data structures (e.g., video file buffers and GPS coordinate tables) on the system disk 1224. The data preparation module 208 is a software routine or set of software routines stored in the system memory 1220 and executed by the processor 1204, the routines comprising instructions for segmenting continuous video streams into discrete video segments of a predetermined duration using a sliding window algorithm, and for storing the segmented video clips in designated watch folder directories on the system disk 1224. The traffic incident detection framework 212 is a software pipeline stored in the system memory 1220 and executed by the processor 1204 and the GPU of the graphics subsystem 1208, the pipeline comprising a sequence of software routines that perform: (i) vehicle identification using a YOLO object detection model with custom-trained weight parameters stored as numerical arrays in the system memory 1220; (ii) vehicle trajectory tracking using a Lucas-Kanade optical flow algorithm that computes frame-to-frame displacement vectors for each detected vehicle centroid; (iii) motion compensation using GPS-derived drone speed data and frame timestamps to subtract drone displacement from vehicle coordinate sequences; (iv) trajectory image generation by rendering compensated vehicle coordinate sequences onto a two-dimensional image array; (v) traffic condition classification using the TCD-Net deep learning model executed on the GPU; (vi) image-to-video aggregation using a threshold-based voting algorithm that computes ratios of image-level classifications; and (vii) incident feature extraction using GPS coordinate integration and arithmetic computations to determine incident scene time periods, congestion lengths, and congestion propagation speeds. The traffic incident detection platform 216 is a web-based software application stored in the system memory 1220 and executed by the processor 1204, the application comprising a web server (e.g., a Django, Flask, or Node.js web server), a set of HTML, CSS, and JavaScript front-end files that render the web-based GUI in a web browser, a set of back-end API endpoints that receive detection results from the traffic incident detection framework 212 and serve the results to the front-end GUI, and a database or file-based storage system for persisting historical detection results and associated metadata.

The TCD-Net architecture 400 and each of its constituent modules are implemented as specific software routines and associated numerical data structures executed by the processor 1204 and the GPU of the graphics subsystem 1208 of the system workstation 116. The data ingestion module 404 is a software routine that reads a trajectory image file from the system disk 1224 or from a memory buffer, decodes the image into a multi-dimensional numerical array (e.g., a NumPy array or a PyTorch tensor) having dimensions corresponding to height, width, and channel count, normalizes pixel intensity values to a predefined range (e.g., [0, 1] or [−1, 1]), and passes the resulting numerical array to the feature extraction module 408. The feature extraction module 408 is a hierarchical stack of three sequential computational layers, each layer comprising a multiscale CNN module 418, a CBAM 420, and an SPP module 424, implemented as a sequence of GPU-accelerated matrix multiplication, convolution, pooling, and element-wise arithmetic operations defined by stored weight parameters and bias parameters. The multiscale CNN module 418 is a set of four parallel two-dimensional convolutional operators, each defined by a stored weight tensor and a stored bias vector, having kernel sizes of 1×1, 1×3, 1×5, and 3×3, respectively, each convolutional operator performing a discrete two-dimensional cross-correlation between its weight tensor and the input feature map, followed by addition of the bias vector and application of a nonlinear activation function (e.g., a Rectified Linear Unit (ReLU) activation function), with the four resulting output feature maps concatenated along the channel dimension and reduced by a 1×1 convolutional operator to produce the combined feature map. The channel attention module 428 of the CBAM 420 is a software routine that computes a global average pooled vector and a global max pooled vector across the spatial dimensions of the input feature map, passes each pooled vector through a shared multi-layer perceptron (MLP) comprising two fully connected layers with stored weight matrices and bias vectors and a ReLU activation function between the layers, sums the two MLP outputs element-wise, applies a sigmoid activation function to produce a channel attention vector, and multiplies the channel attention vector element-wise with each spatial location of the input feature map to produce the channel-weighted feature map. The spatial attention module 432 of the CBAM 420 is a software routine that computes, at each spatial location of the channel-weighted feature map, an average value and a maximum value across the channel dimension to produce two single-channel two-dimensional feature maps, concatenates the two feature maps along the channel dimension, applies a two-dimensional convolutional operator with a stored weight tensor and bias vector followed by a sigmoid activation function to produce a two-dimensional spatial attention map, and multiplies the spatial attention map element-wise with the channel-weighted feature map to produce the spatially-weighted feature map. The SPP module 424 is a software routine that applies adaptive average pooling operations at three spatial resolutions (1×1, 2×2, and 4×4) to the spatially-weighted feature map, flattens each pooled output into a one-dimensional vector, and concatenates the three flattened vectors into a single fixed-length feature vector. The fully connected dense layers and dropout module 412 is a sequence of four fully connected (dense) linear layers, each defined by a stored weight matrix and a stored bias vector, with node counts of 2688, 1024, 256, and 64, respectively, each layer computing a matrix-vector product between its weight matrix and the input vector, adding the bias vector, and applying a ReLU activation function, with dropout regularization (e.g., a dropout probability of 0.5) applied between layers during training by randomly zeroing a fraction of the output activations. The classification module 416 is a fully connected output layer defined by a stored weight matrix and a stored bias vector, having three output nodes corresponding to the three traffic condition classes (normal traffic, recurrent congestion, and incident-induced non-recurrent congestion), followed by a SoftMax activation function that exponentiates each output value and normalizes the exponentiated values by their sum to produce a probability distribution over the three classes, with the class corresponding to the highest probability assigned as the classification result.

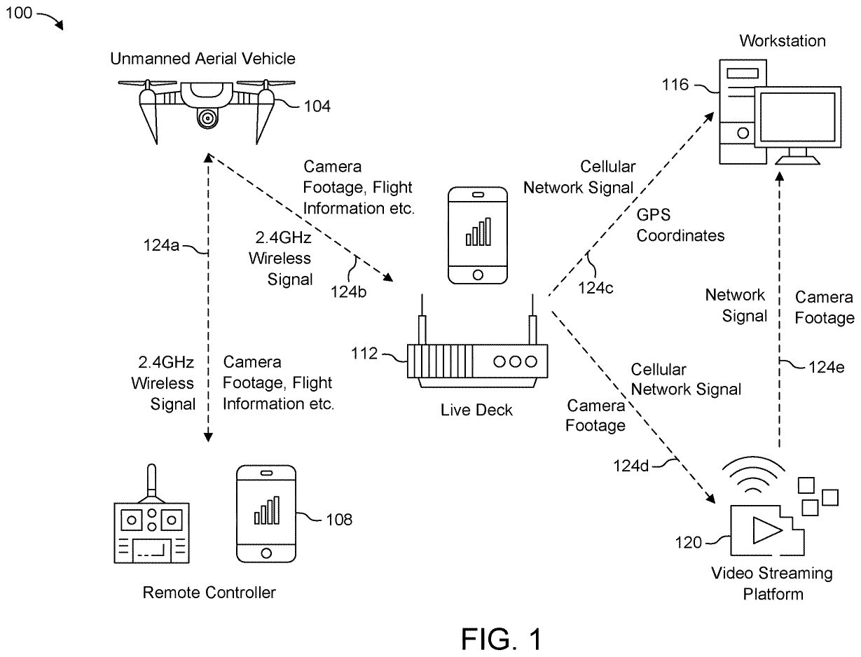

Referring now to FIG. 1, shown is an example system 100 for incident detection, according to the present teachings. As shown, the computing system 100 can include at least one unmanned aerial vehicle (UAV) or drone 104, at least one ground control computing device or first remote controller 108, at least one live deck or second remote controller 112, at least one system workstation 116, and/or at least one livestream platform 120. The drone 104, first remote controller 108, second remote controller 112, system workstation 116, and/or livestreaming platform 120 can be communicatively connected to one another via one or more communication links 124, such as communication links 124a-e.

The drone 104 can be equipped with at least one imaging device to capture real-time video data of traffic flow on freeway corridors from an aerial perspective. In some examples, the imaging device is configured to capture thermal video data, enabling the drone 104 to operate effectively under low-visibility conditions such as nighttime or foggy weather, and to avoid capturing identifiable personal information such as license plates or driver faces. The imaging device can include a thermal camera, a visible-light RGB camera, a dual-mode camera capable of capturing both thermal and visible-light imagery, or any other imaging device suitable for aerial traffic monitoring.

The drone 104 can output at least one signal to the first remote controller 108 including camera footage, flight information, global positioning system (GPS) coordinates, altitude, speed, and operational status of onboard equipment, or the like, for example, over the communication link 124a. In that regard, the communication link 124a between the drone 104 and the first remote controller 108 can include a wireless communication link, such as a 2.4 gigahertz (GHz) wireless communication link, a 5.8 GHz wireless communication link, or other types of wireless communication links suitable for bidirectional communication between the drone 104 and the first remote controller 108. The first remote controller 108 can also transmit real-time control commands and flight mission plans to the drone 104 over the communication link 124a.

The drone 104 can output at least one signal to the second remote controller 112 including camera footage, flight information, GPS coordinates, and other drone telemetry data, or the like, for example, over the communication link 124b. In that regard, the communication link 124b between the drone 104 and the second remote controller 112 can include a wireless communication link, such as a 2.4 GHz wireless communication link, a 5.8 GHz wireless communication link, or other types of wireless communication links suitable for bidirectional communication between the drone 104 and the second remote controller 112.

The first remote controller 108 can be a ground control station or computing device operated by a drone pilot to control the flight of the drone 104. The first remote controller 108 can be implemented as a dedicated drone remote controller, a tablet computer, a laptop computer, a smartphone, or any other computing device capable of communicating with the drone 104 and transmitting real-time control commands and flight mission plans thereto. The first remote controller 108 is designed to receive real-time thermal camera footage and flight status information from the drone 104, and to transmit control commands and flight mission plans to the drone 104 over the communication link 124a.

The second remote controller 112 can be a live deck or drone information-receiving device that serves as a mediator for transmitting drone video and GPS information to the system workstation 116 and the livestream platform 120. In that regard, the second remote controller 112 can decouple drone pilot flight control operations (e.g., performed using the first remote controller 108) from the data transmission functions. The second remote controller 112 can be implemented as a dedicated live deck device provided by the drone manufacturer, a secondary remote controller, a smartphone, a tablet computer, or another computing device capable of receiving data from the drone 104 and forwarding that data to the system workstation 116 and the livestream platform 120. The second remote controller 112 can be designed to receive real-time thermal camera video data and position data from the drone 104 over the communication link 124b, and to transmit the camera footage to the livestream platform 120 and the GPS coordinate data to the system workstation 116.

The second remote controller 112 can output at least one signal to the system workstation 116 including position information associated with the drone 104, such as GPS coordinates of the drone 104. In that regard, the communication link 124c between the second remote controller 112 and the system workstation 116 can include a cellular network signal, such as a 4G LTE signal, a 5G signal, or other cellular network signal types suitable for unidirectional transmission of GPS coordinate data from the second remote controller 112 to the system workstation 116.

The second remote controller 112 can output at least one signal to the livestream platform 120 including camera footage captured using the drone 104. In that regard, the communication link 124d between the second remote controller 112 and the livestream platform 120 can include a cellular network signal, such as a 4G LTE signal, a 5G signal, or other cellular network signal types suitable for unidirectional real-time broadcasting of thermal camera video footage from the second remote controller 112 to the livestream platform 120.

The system workstation 116 can be designed to receive position data from the second remote controller 112, access the livestream platform 120 to record and store the thermal video data broadcast by the drone 104, and execute the traffic incident detection framework to perform real-time incident detection, incident scene time period extraction, and calculation of incident-induced non-recurrent congestion length and propagation speed. The system workstation 116 can visualize incident detection results in real time through a web-based graphical user interface (GUI). In this manner, the system workstation 116 can enable TMC personnel to verify and monitor incidents effectively. The system workstation 116 can be implemented as a desktop computer, a server, a laptop computer, or any other computing device equipped with sufficient processing capability, such as a graphics processing unit (GPU), to execute the traffic incident detection framework in real time. In some examples, the system workstation 116 is equipped with an NVIDIA GeForce RTX 3080 GPU or a comparable GPU.

In some examples, the system workstation 116 executes an operating system such as Ubuntu Linux, Windows, or another operating system capable of supporting GPU-accelerated deep learning inference. The traffic incident detection application 1232 can be implemented as a Python application or a compiled application written in C++ or another programming language, utilizing deep learning frameworks such as PyTorch, TensorFlow, or ONNX Runtime for executing the TCD-Net model on the GPU via CUDA and cuDNN libraries. The traffic incident detection application 1232 can utilize computer vision libraries such as OpenCV for video decoding, frame extraction, vehicle coordinate extraction, optical flow computation, and trajectory image rendering. The system workstation 116 can further include a web server process (e.g., a Django web server, a Flask web server, or a Node.js web server) that serves the web-based GUI of the traffic incident detection platform 216 to client web browsers over HTTP or HTTPS. The system workstation 116 can store GPS coordinate data in a structured data format such as a relational database table (e.g., an SQLite or PostgreSQL table), a CSV file, or an in-memory data structure (e.g., a Python dictionary or a Pandas DataFrame), with each record comprising a timestamp, a latitude value, and a longitude value. Video segments can be stored on the system disk 1224 in a standard video container format such as MP4, AVI, or MKV, encoded using a video codec such as H.264 or H.265.

In some examples, rather than relying solely on the system workstation 116 for processing, the traffic incident detection framework may be deployed on one or more onboard edge computing modules mounted on the drone 104 itself. In such examples, the drone 104 can be equipped with an edge computing device, such as an NVIDIA Jetson AGX Orin or a comparable embedded computing platform, to enable real-time, in-flight processing of thermal video data. The trained deep learning model, such as the TCD-Net described herein, can be deployed onboard the drone 104 and executed locally on the edge computing device. In this configuration, vehicle trajectory extraction, trajectory image generation, and traffic incident detection can be performed onboard the drone 104 during flight, without requiring continuous transmission of raw video data to the system workstation 116. This onboard processing architecture can reduce reliance on network bandwidth and minimize detection latency, which may be advantageous for operations in remote areas or environments with limited wireless connectivity. In some examples, the onboard edge computing module can transmit only processed detection results, such as incident classifications, congestion length estimates, and/or GPS-tagged incident locations, to the system workstation 116 or to a TMC, rather than transmitting raw or unprocessed video streams. This decentralized architecture can support deployment of distributed multi-drone systems in which each drone 104 operates with a degree of computational autonomy, reducing the processing load at the system workstation 116 and enabling scalable freeway monitoring across wider geographic areas.

In examples in which the traffic incident detection framework 212 is deployed on one or more onboard edge computing modules mounted on the drone 104, the edge computing module is a specific embedded computing device comprising a system-on-module (SoM) or system-on-chip (SoC) having an integrated multi-core CPU (e.g., an ARM Cortex-A78AE CPU or a comparable embedded processor), an integrated GPU (e.g., an NVIDIA Ampere architecture GPU with CUDA cores and Tensor Cores, such as the GPU integrated in the NVIDIA Jetson AGX Orin), system memory (e.g., LPDDR 5 RAM having a capacity of at least 16 gigabytes), non-volatile storage (e.g., an eMMC or NVMe SSD), and hardware interfaces for receiving video data from the imaging device (e.g., a MIPI CSI-2 interface or a USB 3.0 interface) and for transmitting processed detection results to the system workstation 116 or a TMC (e.g., via a cellular modem, a Wi-Fi adapter, or a serial communication interface). The edge computing module executes the same software routines and numerical data structures as described for the system workstation 116 implementation of the traffic incident detection framework 212, including the YOLO vehicle detection model, the Lucas-Kanade optical flow tracker, the motion compensation algorithm, the trajectory image generation routine, the TCD-Net deep learning model, the image-to-video aggregation algorithm, and the incident feature extraction algorithm, each optimized for execution on the embedded GPU using inference optimization frameworks such as NVIDIA TensorRT or a comparable model optimization toolkit. The trained weight parameters, bias parameters, and model architecture definition files for the TCD-Net and the YOLO model are stored in the non-volatile storage of the edge computing module and loaded into the system memory during initialization.

The livestream platform 120 can be designed to receive and broadcast real-time thermal camera video footage transmitted by the second remote controller 112, and to make the broadcasted video data accessible to the system workstation 116 over the communication link 124e. The livestream platform 120 can be implemented as one or more backend servers, a distributed cloud-based streaming service, or another platform capable of receiving, hosting, and streaming live video data. The system workstation 116 can access the livestream platform 120 to record the broadcasted drone thermal camera video data and save the video data into discrete video segments for subsequent processing by the traffic incident detection framework.

In some examples, the system 100 can further include one or more roadside drone docking stations positioned along a monitored freeway corridor. The docking stations can serve as ground-based infrastructure to support extended and autonomous drone operations. In some examples, a docking station can function as a charging hub or battery-swapping station, enabling the drone 104 to autonomously land, recharge or exchange batteries, and redeploy without requiring manual intervention by an operator. In some examples, a docking station can provide a sheltered enclosure for the drone 104 during periods of severe weather, such as high winds, heavy rain, or extreme cold, thereby extending the operational availability of the drone 104 under adverse environmental conditions. The docking stations can be implemented using commercially available automated docking systems, such as those provided by DJI or Skydio, or any other docking infrastructure capable of supporting automated takeoff, landing, and battery charging or swapping in remote or roadside settings. In some examples, a network of docking stations can be deployed at intervals along a freeway corridor to enable continuous autonomous patrol operations by one or more drones 104, with each drone 104 autonomously navigating between docking stations as needed to maintain battery charge and extend patrol coverage. This docking station infrastructure can support scalable deployment of the system 100 across extended freeway networks, including remote or resource-constrained areas where frequent manual drone deployment may not be feasible.

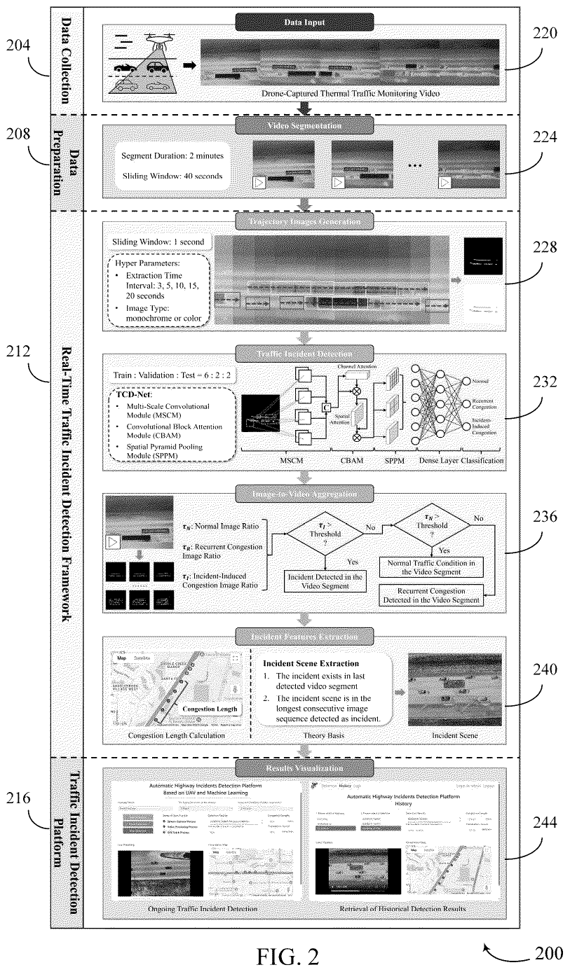

FIG. 2 illustrates an example system architecture 200 for UAV-based incident detection, according to the present teachings. The system architecture 200 can be implemented using one or more components of the system 100 of FIG. 1. For example, the system architecture 200 can be implemented using the system workstation 116 in conjunction with the drone 104, first remote controller 108, second remote controller 112, and/or video streaming platform 120. In the illustrated example, the system architecture 200 can include a data collection module 204, a data preparation module 208, a traffic incident detection framework 212, and a traffic incident detection platform 216.

Each of the data collection module 204, the data preparation module 208, the traffic incident detection framework 212, and the traffic incident detection platform 216 is implemented as a respective set of software routines, scripts, or application processes stored in the system memory 1220 or on the system disk 1224 of the system workstation 116 and executed by the processor 1204 and, where applicable, the GPU of the graphics subsystem 1208. The data collection module 204 comprises software routines that invoke operating system network APIs or streaming client libraries (e.g., FFmpeg, Streamlink, or a comparable streaming client) to connect to the livestream platform 120, receive the broadcasted thermal video data stream, and write the received video data to a file on the system disk 1224. The data collection module 204 further comprises software routines that open a network socket (e.g., a TCP socket or a UDP socket) to receive GPS coordinate data transmitted by the second remote controller 112 over the cellular network, parse the received GPS data packets, and store the parsed GPS coordinates with associated timestamps in a GPS coordinate data structure (e.g., a database table or an in-memory list). The data preparation module 208 comprises software routines that implement a sliding window video segmentation algorithm, in which a timer or scheduler initiates a new video recording subprocess at fixed intervals (e.g., every 40 seconds), each subprocess recording a video segment of a predetermined duration (e.g., two minutes) from the live video stream and saving the recorded segment to a designated watch folder directory on the system disk 1224. The traffic incident detection framework 212 comprises a pipeline of software routines executed sequentially for each video segment, including: a YOLO inference routine that loads the YOLO model weight file from the system disk 1224, processes each video frame through the YOLO neural network on the GPU to produce bounding box coordinates and confidence scores for detected vehicles, and outputs a table of vehicle centroid coordinates; a Lucas-Kanade optical flow routine that computes sparse optical flow vectors between consecutive frames using the OpenCV calcOpticalFlowPyrLK function or a comparable implementation to track vehicle centroids and generate coordinate sequences; a motion compensation routine that retrieves GPS-derived drone speed values from the GPS coordinate data structure, computes per-frame displacement offsets based on drone speed and frame timestamps, and subtracts the computed offsets from the vehicle coordinate sequences; a trajectory image generation routine that maps the compensated vehicle coordinate sequences onto a two-dimensional image array using line-drawing functions (e.g., OpenCV line or polyline functions) and saves or buffers the resulting trajectory image; a TCD-Net inference routine that loads the trained TCD-Net model weight file from the system disk 1224, processes each trajectory image through the TCD-Net neural network on the GPU, and outputs a classification label and associated probability distribution; an image-to-video aggregation routine that computes the ratios of image-level classification labels within a video segment and applies threshold-based decision logic to produce a video-level classification; and an incident feature extraction routine that accesses the GPS coordinate data structure, computes cumulative spatial ranges using the Haversine formula or Euclidean distance calculations on GPS coordinates, and calculates incident scene time periods, congestion lengths, and congestion propagation speeds using arithmetic operations on the computed spatial ranges and elapsed times. The traffic incident detection platform 216 comprises a web server application (e.g., a Django application, a Flask application, or a Node.js application) that exposes RESTful API endpoints for receiving detection results from the traffic incident detection framework 212, stores the detection results in a database (e.g., an SQLite database, a PostgreSQL database, or a file-based JSON store), and serves HTML, CSS, and JavaScript front-end files to client web browsers. The front-end files implement the web-based GUI using a JavaScript mapping library (e.g., Leaflet.js, Google Maps JavaScript API, or Mapbox GL JS) to render the visualization map with geolocated markers, a video player element (e.g., an HTML5 video element or a video.js player) to display the live thermal video stream, and JavaScript event handlers to process operator inputs (e.g., start, pause, stop detection commands) and transmit the inputs to the back-end API endpoints via asynchronous HTTP requests (e.g., AJAX or Fetch API calls).

The data collection module 204 can be designed to perform a data input step 220. The data input step 220 can include collecting thermal traffic monitoring video data from freeway corridors under various traffic conditions, including traffic incident conditions, recurrent congestion conditions, and normal traffic conditions. During the data input step 220, the drone 104 may be operated at a fixed cruising altitude and speed, with the imaging device (e.g., the thermal camera) set to a predetermined azimuth angle and pitch angle, to enable standardized video collection and optimized vehicle identification accuracy. By way of example, the drone 104 can cruise at an altitude of approximately 200 feet and a speed of approximately 10 miles per hour, with the camera azimuth set to 90 degrees and the pitch angle set between 70 and 90 degrees. The thermal video data collected during the data input step 220 can serve as the primary input to the traffic incident detection framework.

The data preparation module 208 can be designed to perform a video segmentation step 224. The video segmentation step 224 can include segmenting the continuous thermal video stream transmitted in real time by the drone 104 into discrete video segments of a predetermined duration. In some examples, the video segments have a duration of approximately two minutes. To enhance the temporal and spatial resolution of incident detection results, a sliding window approach can be applied during segmentation, whereby a new recording subprocess can be initiated at a fixed interval (e.g., every 40 seconds) to capture overlapping two-minute video segments. This sliding window approach can result in overlapping video segments, such as segments covering time intervals [t, t+120 s], [t+40 s, t+160 s], and [t+80 s, t+200 s]. The sliding window approach can enable the system to update incident detection results at the sliding window interval rather than waiting for a full video segment duration. The segmented video clips can be stored in designated watch folders for subsequent processing by the traffic incident detection framework.

The traffic incident detection framework 212 can be designed to perform a trajectory image generation step 228, a traffic incident detection step 232, an image-to-video aggregation step 236, and an incident features extraction step 240. The trajectory image generation step 228 can include identifying vehicles within each thermal video segment, extracting their movement trajectories, and generating a set of vehicle trajectory images at a fixed extraction time period using a sliding window (e.g., a one second sliding window). Specifically, a You-Only-Look-Once (YOLO) model with custom-trained weights can be applied to each video frame to extract the center point coordinates of each identified vehicle. A Lucas-Kanade optical flow tracker can then be employed to track the movement of each vehicle's centroid across consecutive frames, generating coordinate sequences that record vehicle movement. Motion compensation can be performed to eliminate the effect of the drone's own movement from the vehicle trajectory coordinate sequences, based on the drone's GPS-derived speed and the timestamps of each frame. Vehicle trajectories corresponding to opposing traffic lanes can be excluded to avoid incorporating disparate traffic features that could confound incident detection. The resulting vehicle trajectories within each extraction time period can be mapped onto a trajectory image. A predetermined sliding window (e.g., a one second sliding window, a two second sliding window, a half second sliding window, etc.) can be applied to augment the sample size and enhance detection robustness by reducing the adverse impact of isolated misclassifications on overall detection results.

The traffic incident detection step 232 can include processing the vehicle trajectory images generated during the trajectory image generation step 228 using, for example, a customized deep learning model to classify each trajectory image. In some examples, each trajectory image is classified into a respective category selected from normal traffic, recurrent congestion, or incident-induced non-recurrent congestion. The deep learning model, which may be referred to herein as the Traffic Condition Detection Network (TCD-Net), can be a lightweight convolutional neural network (CNN)-based model designed to extract microscopic traffic features from vehicle trajectory images, such as individual vehicle trajectory lengths, lane-changing frequency, and/or vehicle density distributions, and to classify the traffic condition represented in each image. As will be described in greater detail below, the TCD-Net architecture can include a feature extraction module comprising a multiscale CNN module, a Convolutional Block Attention Module (CBAM), and a Spatial Pyramid Pooling (SPP) module, followed by a series of fully connected dense layers that perform multi-class classification.

The image-to-video aggregation step 236 can include aggregating the image-level classification results produced by the TCD-Net for trajectory images within a given video segment to generate a single video-level incident detection result. Specifically, the proportions of trajectory images within the video segment classified as indicating a traffic incident (TI), recurrent congestion (TR), and normal traffic (TN) can be computed. If TI exceeds a predefined incident threshold, the video segment can be classified as capturing a traffic incident or incident-induced non-recurrent congestion. If TI does not exceed the incident threshold but TN exceeds a predefined normal traffic threshold, the video segment can be classified as representing normal traffic conditions. If neither condition is met, the video segment can be classified as capturing recurrent congestion. This aggregation approach can mitigate the influence of isolated misclassifications of individual trajectory images on the overall video-level detection result. In some examples, the incident threshold is set to 0.1 and the normal traffic threshold is set to 0.6.

In some examples, the image-to-video aggregation algorithm comprises the following operations. The image-level classification labels produced by the TCD-Net inference algorithm for all trajectory images derived from the current video segment can be collected. The number of trajectory images assigned each of the three classification labels can be counted: normal traffic (label 0), recurrent congestion (label 1), and incident-induced non-recurrent congestion (label 2). The per-class ratio for each class can be computed by dividing the count of trajectory images assigned that class label by the total number of trajectory images derived from the video segment. The per-class ratios can be compared to predefined classification thresholds: if the ratio of trajectory images classified as incident-induced non-recurrent congestion exceeds a predefined incident threshold (e.g., 0.1 in some examples, or 0.3 in other examples), the video segment can be classified as capturing incident-induced non-recurrent congestion; if the ratio of incident-induced non-recurrent congestion does not exceed the incident threshold but the ratio of trajectory images classified as normal traffic exceeds a predefined normal traffic threshold (e.g., 0.6 in some examples, or 0.5 in other examples), the video segment can be classified as representing normal traffic conditions; if neither condition is satisfied, the video segment can be classified as capturing recurrent congestion. The resulting video-level classification label can be assigned to the video segment and stored together with the segment identifier and timestamp in the detection results data structure for subsequent incident feature extraction and visualization.

The incident features extraction step 240 can include extracting incident-related features from the classified video segments. Incident-related features can include, for example, the location of the incident scene, the length of the incident-induced non-recurrent congestion, and/or the propagation speed of the congestion. To compute the congestion length, GPS coordinates transmitted by the drone 104 to the system workstation 116 at predefined intervals (e.g., one second intervals) can be used to estimate the spatial range covered by each video segment based on segment duration. The total length of incident-induced non-recurrent congestion can be calculated based on the cumulative GPS coordinate range spanned by consecutively incident-classified video segments within a detection flight. In some examples, the propagation speed of the congestion can be calculated as the rate of change in congestion length between two consecutive detection flights that both reported incident presence.

To locate the incident scene, the incident scene may be assumed to fall within the last incident-classified video segment in a sequence of consecutively incident-classified segments from the same detection flight. Within that segment, the specific time interval corresponding to the incident scene can be identified as the time interval covered by the longest consecutive sequence of trajectory images classified as incidents, since vehicles closest to the incident may exhibit the most frequent lane-changing behavior, the slowest speeds, and the highest density.

In some examples, the incident feature extraction algorithm comprises the following operations. All GPS records having timestamps within the time window of the current video segment can be retrieved from the GPS coordinate data structure, identified by matching the segment start and end timestamps to the GPS record timestamps. The incident site GPS coordinate can be identified as the GPS coordinate corresponding to the time interval within the last incident-classified video segment in a sequence of consecutively incident-classified video segments during which the longest consecutive sequence of trajectory images classified as incident-induced non-recurrent congestion was observed, the incident site being assumed to fall within this time interval because vehicles closest to the incident site exhibit the most frequent lane-changing behavior, the slowest speeds, and the highest vehicle density. The upstream congestion boundary GPS coordinate can be identified as the GPS coordinate corresponding to the earliest-time transition from a normal-traffic-classified or recurrent-congestion-classified video segment to an incident-induced non-recurrent congestion-classified video segment within the current detection flight, representing the upstream extent of the incident-induced congestion. The congestion length can be computed as the Haversine distance between the incident site GPS coordinate and the upstream congestion boundary GPS coordinate, expressed in meters or miles. If a prior detection flight during the same detection session also detected incident-induced non-recurrent congestion, the congestion propagation speed can be computed as the difference between the congestion length computed during the current detection flight and the congestion length computed during the prior detection flight, divided by the time interval between the start times of the two detection flights, expressed in meters per second or feet per minute. The computed incident site GPS coordinate, congestion length, and congestion propagation speed can be stored in the detection results record for the current video segment.

The traffic incident detection platform 216 can be designed to perform a results visualization step 244. The results visualization step 244 can include displaying incident detection results, incident scene time periods, congestion length, and/or congestion propagation speed in real time through a web-based GUI accessible to, for example, TMC personnel. The GUI can include a detection webpage and a history review webpage. The detection webpage can display a live thermal video stream from the drone 104, formatted detection results in a dedicated text box, and/or incident locations on an integrated visualization map. As used herein, the term visualization map may refer to an interactive geographic map displayed within the web-based GUI of the traffic incident detection platform, on which geolocated incident detection results may be rendered in real time using distinguishable markers. The visualization map can enable operators to observe the spatial distribution and extent of detected traffic conditions, including incident-induced non-recurrent congestion, recurrent congestion, and/or normal traffic, across the monitored freeway segment.

On the visualization map, incident-induced congestion, recurrent congestion, and/or normal traffic conditions can be represented by color-coded, shape-coded, or other distinguishable markers. For example, incident-induced congestion, recurrent congestion, and/or normal traffic conditions can be represented by red, orange, and green markers, respectively. Control buttons on the detection webpage can enable operators to start, pause, or stop the detection process. A history review webpage can enable operators to select a previously monitored freeway and a specific date and time to access stored detection results and thermal video segments. In this manner, the GUI can enable review of historical traffic conditions. The web-based GUI can employ a responsive design that adapts to both desktop and mobile screen sizes.

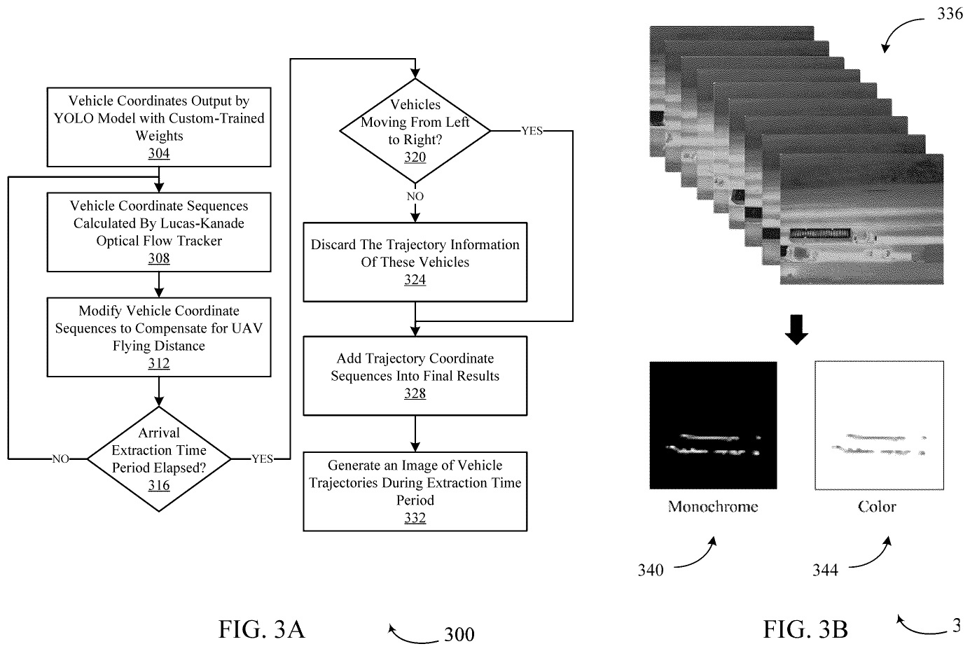

FIG. 3A illustrates an example method 300 for generating vehicle trajectory images, according to the present teachings. The method 300 can be performed by a system computing device, such as the system workstation 116 described with reference to FIG. 1. In some examples, the method 300 is performed by a traffic incident detection framework, such as the traffic incident detection framework 212 described with reference to FIG. 2. In that regard, the method 300 may be performed by the traffic incident detection framework 212 as part of a trajectory image generation step 228.

At step 304, the method 300 can include receiving vehicle coordinates. The vehicle coordinates can be output by, for example, a YOLO model having custom-trained weights. The YOLO model can process each frame of the thermal video segment to identify vehicles and extract the center point coordinates of each identified vehicle. The YOLO model can generate a table of vehicle coordinate information as output for subsequent trajectory tracking. In some examples, the YOLO model can be retrained using manually annotated vehicle bounding boxes from a self-collected thermal video dataset to obtain adapted weight parameters optimized for thermal imagery. In this manner, vehicle detection accuracy for thermal videos can be improved.

In some examples, the vehicle identification algorithm performed by the YOLO model with custom-trained weights comprises the following operations. A video frame can be received as a numerical array having dimensions corresponding to frame height, frame width, and number of color channels. The numerical array can be resized to the YOLO model input resolution (e.g., 416×416 pixels or 640×640 pixels) using bilinear interpolation. Pixel intensity values can be normalized by dividing each value by 255.0 to produce a floating-point array with values in the range [0.0, 1.0]. A batch dimension can be added to produce a four-dimensional input tensor of dimensions [1, C, H, W], where C is the number of channels, H is the input height, and W is the input width, and the tensor can be transferred to GPU memory. A forward pass can be executed through the YOLO convolutional neural network, which applies a sequence of convolutional layers, batch normalization layers, and activation functions to produce a set of predicted bounding box tensors, each bounding box prediction comprising a center x-coordinate, a center y-coordinate, a width, a height, and a confidence score, all expressed as fractions of the input image dimensions. A confidence threshold filter can be applied, retaining only bounding box predictions having a confidence score equal to or greater than a predefined threshold (e.g., 0.5), and discarding all predictions with confidence scores below the threshold. Non-maximum suppression (NMS) can be applied to the retained predictions by computing the Intersection over Union (IoU) between each pair of retained bounding boxes and discarding the lower-confidence box of each pair having an IoU above a predefined NMS threshold (e.g., 0.4), thereby eliminating duplicate detections of the same vehicle. The centroid coordinates of each retained bounding box can be computed as (center_x multiplied by frame width, center_y multiplied by frame height), expressed in pixel coordinates of the original video frame, to produce a table of vehicle centroid coordinates for the current frame.

At step 308, the method 300 can include calculating vehicle coordinate sequences. The vehicle coordinate sequences can be calculated using, for example, a Lucas-Kanade optical flow tracker. The Lucas-Kanade optical flow tracker can track the movement of each vehicle's centroid coordinates frame by frame across consecutive video frames. In this manner, the Lucas-Kanade optical flow tracker can generate a coordinate sequence that records changes in the centroid coordinates of each vehicle throughout the video segment. This tracking process can generate a time series of vehicle center point coordinates that captures the movement trajectory of each identified vehicle.

In some examples, the vehicle trajectory tracking algorithm performed by the Lucas-Kanade optical flow tracker comprises the following operations. The set of tracked feature points for the current extraction time period can be initialized as the vehicle centroid coordinates produced by the YOLO vehicle identification algorithm for the first frame of the extraction time period. An image pyramid can be constructed for each of the current frame and the preceding frame by iteratively downsampling each frame by a factor of two for a predefined number of pyramid levels (e.g., three pyramid levels), producing a sequence of images at progressively coarser spatial resolutions. For each tracked feature point, the iterative Lucas-Kanade optical flow equations can be solved beginning at the coarsest pyramid level and propagating the estimated displacement to each successively finer pyramid level, computing at each level the displacement vector that minimizes the sum of squared intensity differences between a local patch centered on the feature point in the preceding frame and the corresponding patch in the current frame, to produce a sub-pixel displacement vector for each tracked feature point. A forward-backward error filter can be applied by computing the optical flow from the current frame back to the preceding frame for each tracked feature point and discarding any feature point for which the Euclidean distance between the original feature point location and the back-tracked location exceeds a predefined error threshold (e.g., 1.0 pixel), thereby eliminating unreliable tracks. The centroid coordinate of each successfully tracked feature point can be updated by adding the computed displacement vector to the feature point's coordinates in the preceding frame, and the updated coordinates can be appended to the centroid coordinate sequence for the corresponding vehicle. For each new vehicle detected by the YOLO vehicle identification algorithm in the current frame that does not correspond to an existing tracked feature point, a new tracked feature point can be initialized at the centroid coordinates of the new vehicle detection and a new centroid coordinate sequence can be begun for that vehicle.

At step 312, the method 300 can include modifying the vehicle coordinate sequences to compensate for flying distance of the drone 104. Because the drone 104 is also cruising along the freeway while capturing video, the movement of the drone 104 can introduce an offset into the vehicle centroid coordinate sequences. This compensation can be calculated based on the timestamps of each video frame and the drone speed as derived from GPS coordinate data. This compensation can be applied to the vehicle coordinate sequences to remove the drone's motion component, thereby yielding vehicle trajectory coordinate sequences that accurately reflect the actual movement of each vehicle relative to the road.

In some examples, the motion compensation algorithm comprises the following operations. All GPS records having timestamps within the current extraction time period can be retrieved from the GPS coordinate data structure, each record comprising a timestamp expressed as a floating-point Unix epoch value, a latitude value expressed in decimal degrees, and a longitude value expressed in decimal degrees. For each pair of consecutive GPS records within the extraction time period, the ground distance between the two GPS coordinate pairs can be computed using the Haversine formula: d=2r×arcsin(sqrt(sin²((lat₂−lat₁)/2)+cos(lat₁)×cos(lat₂)×sin²((lon₂−lon₁)/2))), where r is the mean radius of the Earth (approximately 6,371,000 meters), lat₁ and lat₂ are the latitudes of the two records in radians, and lon₁ and lon₂ are the longitudes of the two records in radians. The instantaneous drone ground speed for each GPS interval can be computed as the computed ground distance divided by the time interval between the two GPS records, expressed in meters per second. For each video frame within the extraction time period, the cumulative displacement of the drone from the start of the extraction time period can be computed by multiplying the instantaneous drone ground speed applicable to the frame's timestamp by the elapsed time from the start of the extraction time period to the frame's timestamp, expressed in seconds, to produce a cumulative displacement value in meters. The cumulative displacement value can be converted from meters to pixels using an altitude-derived scale factor computed as the ratio of the drone's cruising altitude (in meters, as derived from the drone's onboard altimeter or GPS altitude data) to the focal length of the imaging device (in meters, as derived from the imaging device's field of view and sensor dimensions), multiplied by the image resolution in pixels per meter at the drone's cruising altitude. The computed per-frame pixel offset vector, directed along the axis of drone travel as determined from the GPS coordinate sequence, can be subtracted from each vehicle centroid coordinate in the corresponding frame of the centroid coordinate sequences, yielding motion-compensated centroid coordinate sequences that represent actual vehicle movement relative to the road surface.

At step 316, the method 300 can include determining whether an arrival extraction time period has elapsed. For example, the arrival extraction time period can define the fixed duration over which vehicle trajectories are accumulated before a trajectory image is generated, and can be set to a value such as 3 seconds, 5 seconds, 10 seconds, 15 seconds, or 20 seconds. A longer extraction period can capture more complete vehicle trajectories and provide richer spatiotemporal features for the deep learning model.

Responsive to determining that the arrival extraction time period has not elapsed (NO at step 316), the method 300 can include repeating steps 312-316 to continue accumulating vehicle coordinate sequences until the extraction period has elapsed. Responsive to determining that the arrival extraction time period has elapsed (YES at step 316), the method 300 can proceed to step 320.

At step 320, the method 300 can include determining whether the vehicles are detected as moving from the left to the right. For example, the direction of vehicle movement can be assessed based on the accumulated vehicle coordinate sequences to determine whether each vehicle is traveling in the primary monitored traffic direction. The primary monitored direction can correspond to movement from the left side to the right side of the captured video frame. However, in other examples, the primary monitored direction can correspond to movement from the right side to the left side of the captured video frame. This directional filtering ensures that the trajectory image generation process captures vehicle trajectories corresponding to a single traffic lane direction, mitigating issues arising from significant traffic flow differences in opposite directions that could lead to misrecognition of vehicle trajectories.

At step 324, responsive to determining that vehicles are not detected as moving from the left to the right (NO at step 320), the method 300 can include discarding the trajectory information of the one or more vehicles not detected as moving from the left to the right.

At step 328, the method 300 can include adding the trajectory coordinate sequences into final detection results. The trajectory coordinate sequences for vehicles confirmed as moving in the monitored direction can be compiled into a final table for the current computation cycle, which records the time series of vehicle centroid coordinates from the video segment. The operations of step 328 can be performed responsive to discarding trajectory information at step 324 or responsive to determining that all vehicles are detected as moving from the left to the right (YES at step 320).

At step 332, the method 300 can include generating an image of vehicle trajectories during the extraction time period. For example, the accumulated vehicle centroid coordinate sequences for the extraction time period can be rendered onto a trajectory image by plotting the movement paths of all identified vehicles. The trajectory image can be generated in monochrome or color format. Monochrome trajectory images may emphasize structural and edge features of vehicle trajectories, while color trajectory images may incorporate additional chromatic information. In some examples, monochrome trajectory images are used, as they have been found to yield superior classification performance by the TCD-Net model. After the trajectory image is generated, the algorithm can advance the sliding window by one second and proceed to the next extraction period.

In some examples, the trajectory image generation algorithm comprises the following operations. A two-dimensional image array of dimensions 56×56 pixels can be initialized with a uniform background value (e.g., zero for a black background in a monochrome image, or a predefined background color for a color image). The spatial extent of the motion-compensated centroid coordinate sequences for the current extraction time period can be determined by computing the minimum and maximum x-coordinate values and the minimum and maximum y-coordinate values across all centroid coordinates in all sequences. For each tracked vehicle having a centroid coordinate sequence of length greater than one within the current extraction time period, the motion-compensated centroid coordinate sequence can be normalized to the image pixel coordinate space by applying a linear scaling transformation that maps the spatial extent of the coordinate sequences to the [0, 55] pixel range in both the x and y dimensions. The normalized centroid coordinate sequence for each tracked vehicle can be rendered as a polyline on the two-dimensional image array by applying a line-drawing function (e.g., the OpenCV cv2.polylines function or the OpenCV cv2.line function applied iteratively to consecutive coordinate pairs) with a predefined line color (e.g., white for monochrome images, or a predefined color for color images) and a predefined line thickness (e.g., one pixel). After rendering all tracked vehicle trajectories, the completed two-dimensional image array can be saved to a file in a standard image format (e.g., PNG or JPEG) or buffered in memory for direct input to the TCD-Net inference routine. The sliding window can then be advanced by one second and the foregoing operations can be repeated for the next extraction time period.

FIG. 3B illustrates an example visualization 334 of the trajectory image generation performed using the method 300. The visualization 334 depicts an output of the trajectory image generation process for a single extraction time period, showing the movement paths of identified vehicles plotted as trajectory lines on the image. The visualization 334 includes a monochrome trajectory image 340, in which vehicle trajectories are rendered in grayscale to emphasize structural and edge features, and a color trajectory image 344, in which vehicle trajectories are rendered using color information to highlight additional chromatic features. In normal traffic conditions, trajectory images may exhibit relatively long, smooth, and parallel trajectory lines corresponding to vehicles traveling at normal speeds. In incident or incident-induced congestion conditions, trajectory images may exhibit shorter, denser, or more irregular trajectory patterns corresponding to reduced vehicle speeds, increased lane-changing behavior, and higher vehicle density near the incident site.

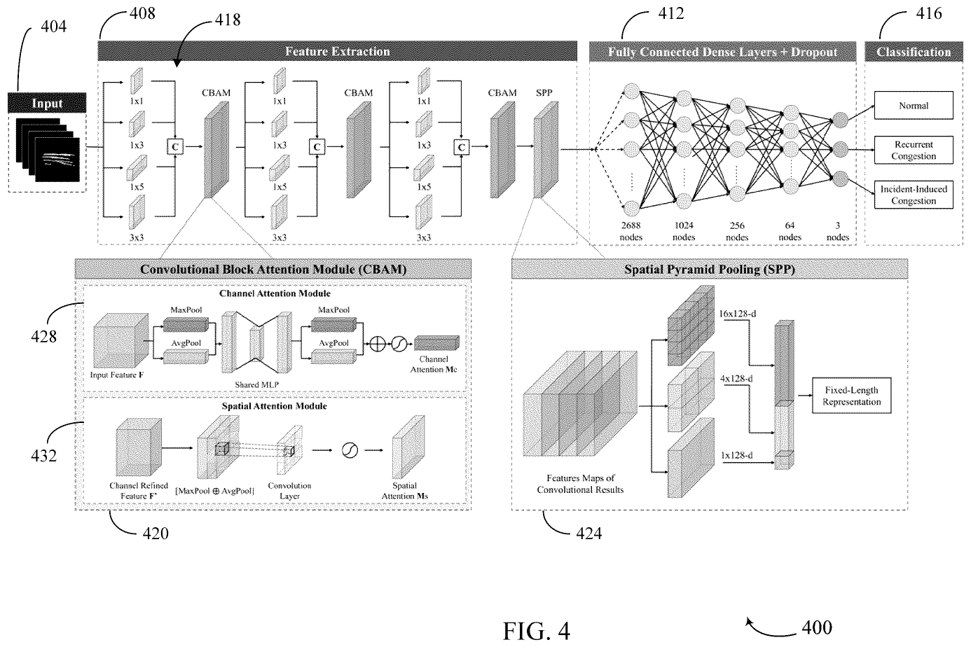

FIG. 4 illustrates an example TCD-Net architecture 400 that may be implemented in conjunction with the system 100 of FIG. 1, according to the present teachings. In some examples, the TCD-Net architecture 400 is implemented as part of the traffic incident detection step 232 described with reference to FIG. 2. In that regard, the TCD-Net architecture 400 can be designed to perform the traffic incident detection step 232 described with reference to FIG. 2.

The TCD-Net architecture 400 can include a data ingestion module 404, a feature extraction module 408, a fully connected dense layers and dropout module 412, and a classification module 416.

Each of the data ingestion module 404, the feature extraction module 408, the fully connected dense layers and dropout module 412, and the classification module 416 is implemented as a respective set of layers, operations, and associated stored parameters (weight tensors and bias vectors) within a deep learning model definition (e.g., a PyTorch nn.Module subclass, a TensorFlow Keras Model subclass, or a comparable model definition object). The model definition is instantiated in the system memory 1220 of the system workstation 116, and the stored parameters are loaded from a serialized model file (e.g., a .pt file, a .pth file, a .h5 file, or an ONNX file) stored on the system disk 1224. During inference, input data and intermediate results are represented as multi-dimensional numerical arrays (tensors) stored in GPU memory, and each layer performs specific GPU-accelerated arithmetic operations (e.g., matrix multiplications, convolutions, element-wise multiplications, pooling reductions, and nonlinear activation functions) on the input tensors using the stored weight and bias parameters to produce output tensors. The data ingestion module 404 is implemented as an image loading and preprocessing routine that reads an image file or receives an image array, converts the image to a floating-point tensor of dimensions [1, C, 56, 56] where C is the number of input channels (C=1 for monochrome, C=3 for RGB), normalizes pixel values, and transfers the tensor to GPU memory. The feature extraction module 408 is implemented as a sequential stack of three identical layer blocks, each layer block comprising a multiscale CNN module 418 instance, a CBAM 420 instance, and an SPP module 424 instance, with the output tensor of each layer block serving as the input tensor to the next layer block. The fully connected dense layers and dropout module 412 is implemented as a sequence of four nn.Linear layers (or equivalent dense layer objects) with ReLU activation functions and nn.Dropout layers (or equivalent dropout layer objects) interleaved between the linear layers. The classification module 416 is implemented as a single nn.Linear layer (or equivalent dense layer object) with three output nodes followed by a nn.Softmax layer (or equivalent softmax layer object) applied along the class dimension.

The data ingestion module 404 can be designed to receive vehicle trajectory images generated by the trajectory image generation step 228 described with reference to FIG. 2. In some examples, each input trajectory image has a resolution of 56×56 pixels and is provided in monochrome format as a single-channel image encoding grayscale intensity values. In some examples, each input trajectory image is provided in color format as a multi-channel image having a plurality of color channels, such as three channels corresponding to red, green, and blue (RGB) color components. The data ingestion module 404 can provide the received trajectory images as input to the feature extraction module 408 for subsequent feature extraction and classification.

The feature extraction module 408 can be designed to extract microscopic traffic features from the input vehicle trajectory images through a hierarchical architecture comprising a set of stacked layers. Each layer can include a multiscale CNN module 418, a CBAM 420, and an SPP module 424. The first layer of the feature extraction module 408 can receive the input trajectory image, and each subsequent layer can receive the fixed-length feature vector output by the SPP module 424 of the immediately preceding layer. The multiscale CNN module 418 can apply a set of convolutional kernels of different sizes to capture features at multiple scales corresponding to different vehicle trajectory characteristics. For example, the CNN module 418 can apply four kernels having sizes 1×1, 1×3, 1×5, and 3×3, respectively. The 1×1 kernel can be used to detect point features corresponding to stationary or near-stationary vehicles. The 1×3 kernel can target short trajectory features corresponding to vehicles with slow speeds. The 1×5 kernel can capture longer trajectory patterns corresponding to vehicles with higher speeds. The 3×3 kernel can be designed to extract lane-changing features. The plurality of feature maps produced by the respective convolutional kernels can be combined, for example by concatenation along the channel dimension, into a combined feature map that aggregates the multi-scale feature representations. In some examples, a 1×1 convolution is applied to the concatenated feature maps to reduce channel dimensionality and fuse the multi-scale feature representations into the combined feature map. By stacking three layers of this combined structure, the feature extraction module 408 can progressively aggregate feature representations from local to global and from low-level to high-level semantics. In this manner, the feature extraction module 408 can expand the receptive field and improve the capacity of the model to characterize complex traffic behavior patterns.

The CBAM 420 can be a lightweight attention mechanism that is integrated into each layer of the feature extraction module 408 following the multiscale CNN module 418. The CBAM 420 can be designed to adaptively recalibrate intermediate feature maps, enhancing the model focus on key information and suppressing redundant or irrelevant features. As used herein, the term feature map may refer to a multi-channel spatial representation produced as an intermediate output by a given CNN module 418 or CNN layer 418 within the feature extraction module 408 of the TCD-Net during processing of a vehicle trajectory image. Each feature map may encode learned spatial and channel-wise information corresponding to traffic features or characteristics extracted at a particular stage of the TCD-Net.

In some examples, the CBAM 420 includes a channel attention module 428 and a sequentially-applied spatial attention module 432. The channel attention module 428 can apply both global average pooling and global max pooling across each channel of the input feature map to extract global channel-wise information. The pooled outputs can be passed through a shared multi-layer perceptron (MLP) and combined to generate a channel attention map. The channel attention map can be used to reweight each channel according to channel importance to the classification task.

The spatial attention module 432 can receive the channel-refined feature map as input and apply average pooling and max pooling along the channel dimension to generate two two-dimensional feature maps. These feature maps can be concatenated and passed through a convolutional layer to produce a spatial attention map, or spatial weight map, that highlights the spatial regions most relevant to the classification task. The spatial attention map can be element-wise multiplied with the channel-weighted feature map to produce a spatially-weighted feature map that emphasizes both the most informative channels and the most relevant spatial locations. By way of example, the channel attention module 428 can focus on what features are important, while the spatial attention module 432 can focus on where those features are located within the image.

The SPP module 424 can be incorporated following the CBAM 420 in each layer of the feature extraction module 408 to enhance the capacity of the model to represent multi-scale spatial features while mitigating the information loss typically associated with conventional single-scale pooling operations. The SPP module 424 can perform pooling at multiple spatial scales—for example, 1×1, 2×2, and 4×4—by dividing the input feature map into sub-regions of varying sizes and extracting representative responses from each sub-region. This hierarchical pooling strategy can enable the model to simultaneously capture both global structural patterns and fine-grained local details. The pooled outputs from the different scales can be flattened and concatenated into a fixed-length feature vector, which facilitates processing in the subsequent fully connected layers and enhances the model's discriminative power in the feature space. The SPP module 424 can thereby serve as a complementary component in the overall multi-scale feature fusion strategy, preserving meaningful features across multiple spatial scales while maintaining a simple and efficient architecture.

The fully connected dense layers and dropout module 412 can be designed to receive the fixed-length feature vector output by the SPP module 424 of the final layer of the feature extraction module 408 and to progressively reduce the dimensionality of the extracted features through a series of fully connected dense layers. In some examples, the fully connected dense layers and dropout module 412 comprises four fully connected layers with 2688, 1024, 256, and 64 nodes, respectively. Dropout regularization can be applied between the dense layers to reduce overfitting during training. The module 412 can integrate and fuse the high-dimensional features extracted by the feature extraction module 408, compress them into a lower-dimensional representation, and pass the resulting compressed features to the classification module 416.

The classification module 416 can be designed to receive the compressed feature representation output by the fully connected dense layers and dropout module 412 and to map the representation to one of the plurality of traffic condition classes. For example, the classification module 416 can map the representation to one of normal traffic, recurrent congestion, or incident-induced non-recurrent congestion. In some examples, the classification module 416 comprises a fully connected output layer with three nodes, one corresponding to each traffic condition class, followed by a SoftMax activation function that produces a probability distribution over the three classes. The class with the highest predicted probability may be assigned as the classification result for the input trajectory image.

In some examples, the TCD-Net inference algorithm comprises the following operations. The trajectory image can be loaded and decoded from a file or memory buffer into a numerical array of dimensions [H, W, C], where H and W are the image height and width in pixels and C is the number of channels (C=1 for monochrome images, C=3 for RGB color images). The numerical array can be resized to dimensions [56, 56, C] using bilinear interpolation if the image dimensions differ from 56×56 pixels. Pixel intensity values can be normalized by dividing each value by 255.0 to produce a floating-point array with values in the range [0.0, 1.0]. The array can be transposed to channel-first format [C, 56, 56] and a batch dimension can be added to produce a four-dimensional tensor of dimensions [1, C, 56, 56]. The tensor can be transferred to GPU memory. A forward pass can be executed through the TCD-Net model in inference mode (with dropout layers deactivated), comprising: passing the input tensor through the data ingestion module 404 to produce a preprocessed input tensor; passing the preprocessed input tensor sequentially through each of the three feature extraction layer blocks of the feature extraction module 408, each block comprising a multiscale CNN module 418 that applies four parallel convolutional operators with kernel sizes 1×1, 1×3, 1×5, and 3×3 and fuses the resulting feature maps, a CBAM 420 that applies channel attention and spatial attention recalibration, and an SPP module 424 that performs pooling at 1×1, 2×2, and 4×4 spatial resolutions and concatenates the pooled outputs into a fixed-length feature vector; passing the fixed-length feature vector output by the final feature extraction layer block through the four fully connected dense layers of the fully connected dense layers and dropout module 412, with ReLU activation functions applied after each layer; and passing the output of the final dense layer through the classification module 416, comprising a fully connected output layer with three nodes followed by a SoftMax activation function, to produce a probability distribution over the three traffic condition classes. The class corresponding to the highest probability in the SoftMax output probability distribution can be selected as the image-level classification label for the input trajectory image.

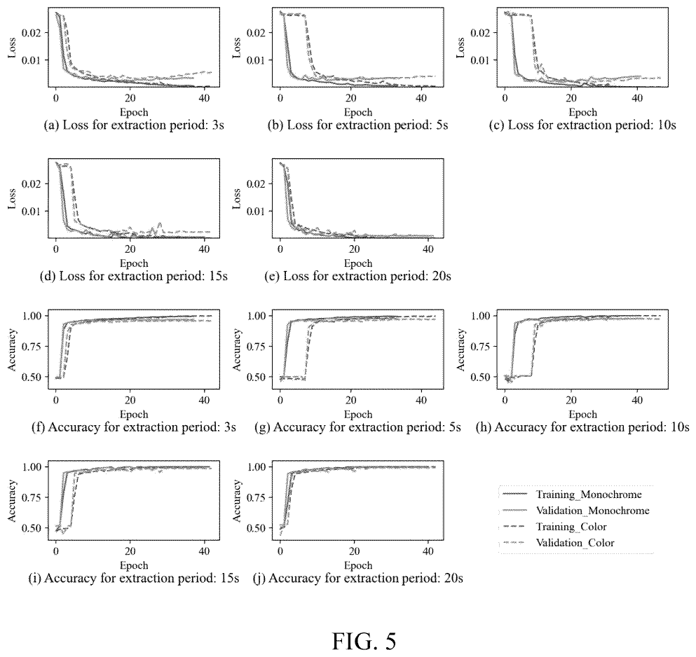

FIG. 5 illustrates example loss and accuracy curves associated with a training and testing of the TCD-Net architecture 400 described with reference to FIG. 4. Subfigures (a) through (e) depict the variation of loss over training epochs on the test set under five different vehicle trajectory extraction time periods (e.g., 3 seconds, 5 seconds, 10 seconds, 15 seconds, and 20 seconds) and two image modes (monochrome and color). Subfigures (f) through (j) illustrate the corresponding accuracy curves over training epochs for the same configurations.

In the examples of FIG. 5, the loss curves demonstrate that the TCD-Net trained using trajectory images extracted with a 20-second time period achieved the lowest final loss values on both the training and test sets across all configurations. The accuracy curves show that across all five trajectory extraction periods, the TCD-Net models reached test set accuracies approaching 100%.

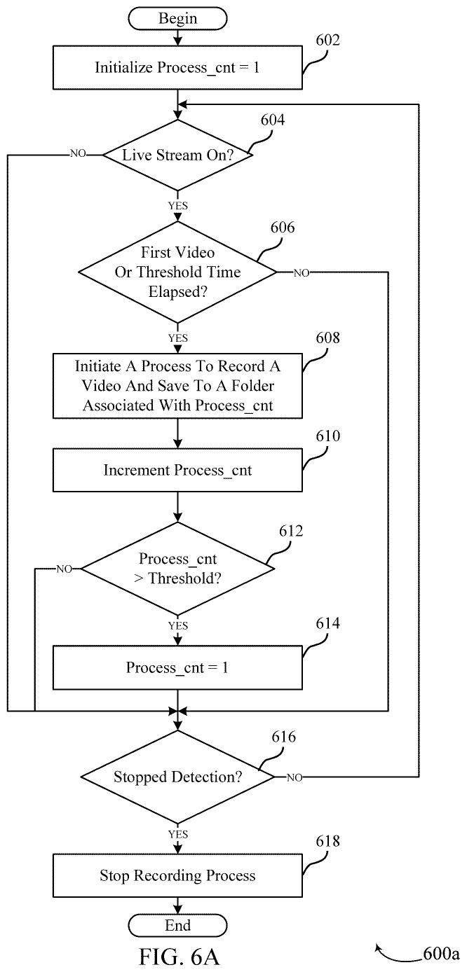

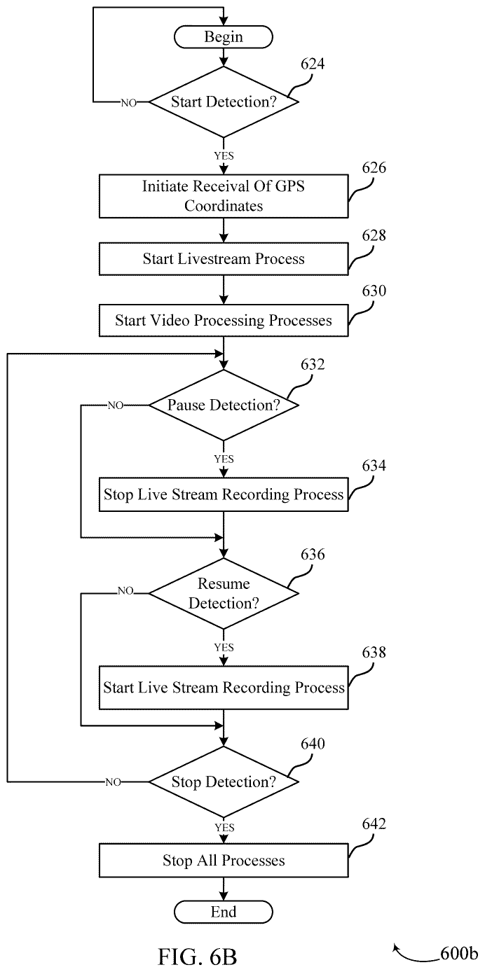

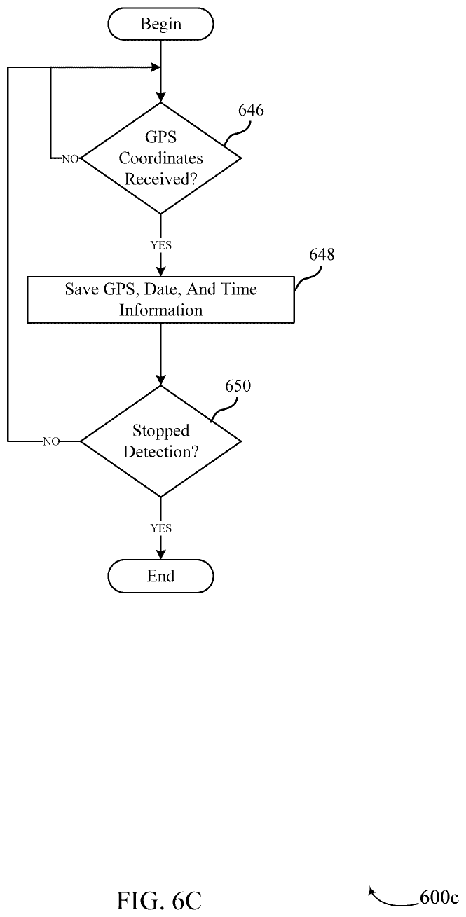

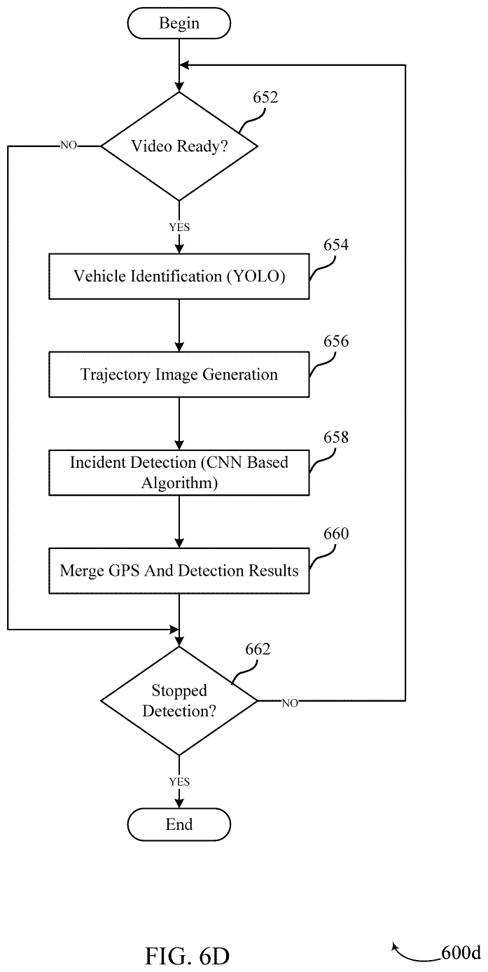

FIGS. 6A-6D illustrate example processes 600a-600d for performing drone-based traffic incident detection. In some examples, some or all of the operations of the processes 600a-600d may be performed by, for example, the traffic incident detection framework 212 described with reference to FIG. 2. In some examples, portions of the processes 600a-600d are performed in parallel with one another.

FIG. 6A illustrates an example video live streaming process 600a. At step 602, the process 600a can include initializing a counter Process_cnt to a starting value (e.g., a starting value of 1). The counter Process_cnt is used to tag and track the three distinct overlapping time intervals associated with the sliding window video recording scheme, ensuring that video segments recorded during each time interval are stored in the correct designated watch folder and subsequently processed by the corresponding incident detection process.

At step 604, the process 600a can include determining whether a live stream operation for the drone 104 is active. For example, the process 600a can monitor a status signal from the livestream platform 120 or the second remote controller 112 to determine whether the drone 104 is actively broadcasting thermal camera video data. If the live stream is not active, the process 600a may proceed to step 616 to check whether a stop detection command has been received.

At step 606, the process 600a can include, responsive to determining that a live stream operation is active (YES at step 604), determining whether a first video has been captured or a threshold period of time has elapsed. The first video condition may be satisfied at the start of a detection session, triggering the initiation of the first video recording subprocess. The threshold period of time can correspond to the sliding window interval of the video recording scheme. In some examples, the threshold period of time is set to approximately 40 seconds, 30 seconds, or the like. When the threshold period of time has elapsed since the last recording subprocess was initiated, a new recording subprocess can be triggered to capture the next overlapping two-minute video segment.

At step 608, the process 600a can include, responsive to determining that a first video has been captured or a threshold period of time has elapsed (YES at step 606), initiating a process to record a video of the traffic environment and save the video to a folder associated with the process counter. For example, a subprocess can be launched to record a two-minute video segment of the thermal camera footage broadcast on the livestream platform 120, and the recorded video segment can be saved to a watch folder designated by the current value of the process counter Process_cnt (e.g., WatchFolder_1, WatchFolder_2, or WatchFolder_3). The watch folder designation can enable correct association of each video segment with a corresponding time interval, and can enable accessibility to the corresponding incident detection process for real-time analysis.

At step 610, the process 600a can include incrementing the process counter Process_cnt. The increment advances the counter to the next value, associating the next video recording subprocess with the subsequent watch folder in the sequence, and thereby enabling consecutive overlapping video segments to be stored in distinct watch folders for independent processing by the corresponding incident detection processes.

At step 612, the process 600a can include determining whether the process counter Process_cnt has reached a threshold value. The threshold value can correspond to the total number of overlapping time intervals in the sliding window recording scheme. As an example, a threshold value set to three can correspond to three watch folders and three concurrent incident detection processes. The process counter Process_cnt reaching the threshold value can indicate that a complete video recording cycle (e.g., a two minute video recording cycle) has been completed, during which the threshold number of overlapping video segments (e.g., three overlapping video segments) have been stored in corresponding watch folders.

At step 614, the process 600a can include, responsive to determining that the process counter Process_cnt has reached a threshold (YES at step 612), reinitializing the process counter Process_cnt to the starting value (e.g., the starting value of 1). In some examples, the reinitialization can commence a new mini-cycle of video recording. In this manner, the reinitialization can enable subsequent video segments to again be stored in the watch folders in the correct sequence and that the sliding window recording scheme continues without interruption.

At step 616, the process 600a can include determining whether an input to stop incident detection has been received. The input to stop incident detection can be received from an operator via the web-based GUI, for example, by the operator activating a stop detection control on the detection webpage. In some examples, step 616 is performed responsive to determining that a live stream operation is not active (NO at step 604). In some examples, step 616 is performed responsive to determining that a first video has not been captured or that a threshold period of time has not elapsed (NO at step 606).

At step 618, responsive to determining that an input to stop incident detection has been received (YES at step 616), the process 600a can include outputting a control signal to stop the recording process. For example, the process 600a can terminate all active recording subprocesses and clears any scheduled recording tasks, effectively stopping the recording of new video segments and concluding the live video recording process.

In some examples, responsive to determining that an input to stop incident detection has not been received (NO at step 616), the process 600a includes repeating steps 604-616.

FIG. 6B illustrates an example control process 600b for performing traffic incident detection with respect to a live stream of video data, according to the present teachings. In some examples, the live stream of video data can be captured using the process 600a described with reference to FIG. 6A.

At step 624, the process 600b can include determining whether an input to start incident detection has been received. The input to start incident detection can be received from an operator via the web-based GUI, for example, by the operator activating a start detection control on the detection webpage after entering the freeway name, the flying direction of the drone 104, and/or the expected duration of video segments. Responsive to receiving the start detection input, the process 600b activates the GPS information receiving process, the live video recording process, and the incident detection processes.

At step 626, the process 600b can include, responsive to determining that incident detection has started (YES at step 624), initiating the receival of position information (e.g., GPS coordinates) from the drone 104. The GPS information receiving process can be initiated to begin receiving and storing timestamped GPS coordinate data transmitted by the drone 104 to the system workstation 116 via the second remote controller 112. In this manner, the GPS information can enable real-time location tracking of the drone 104 and subsequent geolocation of incident detection results. The GPS information receiving process may be described in further detail with reference to FIG. 6C.

At step 628, the process 600b can include outputting a control signal to initiate a live streaming process. The control signal can trigger the live video recording process to begin recording the thermal camera footage broadcast by the drone 104 on the livestream platform 120 and saving the recorded footage into discrete video segments for subsequent incident detection processing. In some examples, the signal output at step 628 of the process 600b is received as input to step 604 of the process 600a.

At step 630, the process 600b can include initiating one or more video processing processes. For example, three concurrent incident detection processes can be initiated, each monitoring a designated watch folder for new video segments. Responsive to detecting the presence of a video segment in a designated watch folder, each incident detection process may initiate the incident detection algorithm. As described above, the incident detection algorithm can perform vehicle identification, trajectory image generation, TCD-Net-based incident classification, and GPS coordinate integration to produce a geolocated incident detection result for the video segment.

At step 632, the process 600b can include determining whether an input to pause incident detection has been received. For example, the input to pause incident detection can be received from an operator via the web-based GUI by the operator activating a pause detection control on the detection webpage. When the detection process is paused, the live video recording process may be halted, stopping the recording of new video segments. In some examples, when the detection process is paused, the incident detection processes may continue processing any video segments already present in the watch folders until those segments have been fully analyzed.

At step 634, responsive to determining that an input to pause incident detection has been received (YES at step 632), the process 600b can include outputting a control signal to stop the livestream recording process. For example, the control signal suspends the live video recording subprocesses, preventing the initiation of new video recording subprocesses and thereby stopping the recording of new video segments while allowing the incident detection processes to complete processing of any video segments already in the watch folders.

At step 636, the process 600b can include determining whether an input to resume incident detection has been received. For example, the input to resume incident detection can be received from an operator via the web-based GUI by the operator activating a resume detection control on the detection webpage, which replaces the pause detection control when the detection process is in a paused state.

At step 638, the process 600b can include, responsive to receiving an input to resume incident detection (YES at step 636), outputting a control signal to initiate a live stream recording process. For example, the control signal restarts the live video recording subprocesses, resuming the recording of new video segments from the point at which the detection was paused, with the process counter Process_cnt adjusted to align with the current time interval to ensure continuity in the recording sequence.

At step 640, the process 600b can include determining whether an input to stop incident detection has been received. For example, the input to stop incident detection can be received from an operator via the web-based GUI by the operator activating a stop detection control on the detection webpage. When a stop detection input is received, all incident detection processes, the live video recording process, and/or the GPS information receiving process may be terminated.

At step 642, responsive to determining that an input to stop incident detection has been received (YES at step 640), the process 600b can include outputting a control signal to stop all incident detection processes. For example, the control signal can terminate the live video recording process, all concurrent incident detection processes, and/or the GPS information receiving process. In this manner, the entire detection task can be effectively halted, and the detection session can be concluded.

In some examples, when an input to stop incident detection has not been received (NO at step 640), the process 600b can include repeating steps 632-640.

FIG. 6C illustrates an example process 600c for receiving position information associated with the drone 104, according to the present teachings. In some examples, the process 600c is initiated by one or more control signals generated using the process 600b described with reference to FIG. 6B. For example, the process 600c may be initiated by a control signal generated at step 626 of the process 600b.

At step 646, the process 600c can include determining whether position information (e.g., GPS coordinates) has been or is actively being received. For example, the process 600c can monitor an incoming data stream from the second remote controller 112 to determine whether GPS coordinate data transmitted by the drone 104 is being received at the system workstation 116. The GPS coordinates can be transmitted by the drone 104 at predefined intervals (e.g., half second intervals, one second intervals, two second intervals, or the like), providing continuous real-time location tracking of the drone 104 throughout the detection flight.

At step 648, responsive to determining that position information has been received or is actively being received (YES at step 646), the process 600c can include storing the position information, date information, and/or time information associated with the position information. For example, the received GPS coordinates are stored together with the corresponding date and time metadata in a GPS coordinate table on the system workstation 116. This timestamped GPS data can be subsequently accessed by the incident detection processes to integrate GPS coordinate information into the detection results of each processed video segment, enabling real-time geolocation and visualization of incident detection results on a map.

At step 650, the process 600c can include determining whether an input to stop incident detection has been received. For example, the process 600c can continuously monitor for a stop detection command issued by the main process 600b. If a stop detection command has been received, the GPS information receiving process may terminate and cease to log further GPS coordinate data.

The process 600c may end responsive to a determining that an input to stop incident detection has been received (YES at step 650). Responsive to determining that an input to stop incident detection has not been received (NO at step 650), the process 600c may repeat step 646-650.

FIG. 6D illustrates an example process 600d for performing incident detection, according to the present teachings. In some examples, the process 600d is initiated by one or more control signals generated using the process 600b described with reference to FIG. 6B. For example, the process 600d may be initiated by a control signal generated at step 630 of the process 600b.

At step 652, the process 600d can include determining whether a video is available for processing. For example, the process 600d can monitor a designated watch folder to check for the presence of new video segments. A video segment may be considered available for processing when it has been fully recorded and saved to the watch folder by, for example, the live video recording process 600a. If no video segment is available, the process 600d may continue monitoring the watch folder until a new video segment is detected.

At step 654, responsive to determining that a video is available for processing (YES at step 652), the process 600d can include performing vehicle identification. The vehicle identification can be performed as, for example, a YOLO identification. The YOLO model with custom-trained weights can be applied to each frame of the available video segment to identify vehicles and extract the center point coordinates of each identified vehicle, producing a table of vehicle coordinate information for each frame. This vehicle coordinate data can serve as the input to the subsequent trajectory image generation step.

At step 656, the process 600d can include generating one or more trajectory images associated with identified vehicles. The Lucas-Kanade optical flow tracker can be applied to the vehicle coordinate data to track the movement of each vehicle's centroid across consecutive frames, generating vehicle coordinate sequences. Motion compensation can be applied to remove the drone's movement from the coordinate sequences. Vehicle trajectories corresponding to opposing traffic lanes may be excluded. The resulting vehicle trajectories within each extraction time period can be rendered onto a trajectory image using a one-second sliding window approach to produce a set of trajectory images for the video segment that serve as input to the incident detection model.

At step 658, the process 600d can include performing incident detection using the trajectory images. The TCD-Net model can classify each trajectory image as indicating normal traffic, recurrent congestion, or incident-induced non-recurrent congestion. The image-level classification results for all trajectory images within the video segment may then be aggregated using the image-to-video aggregation method to produce a single video-level incident detection result. If an incident is detected, the incident features extraction algorithm may be applied to determine the incident scene time period, the length of the incident-induced non-recurrent congestion, and, if a prior detection flight also detected an incident, the propagation speed of the congestion.

At step 660, the process 600d can include merging position information with incident detection results. For example, the GPS coordinate data stored by the GPS information receiving process 600c can be accessed and integrated with the incident detection results for the processed video segment. The GPS coordinates corresponding to the time span of the video segment are used to geolocate the detection results, enabling real-time visualization of incident locations and congestion extent on the map displayed in the web-based GUI.

At step 662, the process 600d can include determining whether an input to stop incident detection has been received. For example, the process 600d can monitor for a stop detection command issued by the main process 600b. The stop detection command can be received when an operator activates the stop detection control on the web-based GUI, or when the main process 600b terminates all processes upon receiving a stop detection input.

In some examples, the process 600d ends responsive to determining that an input to stop incident detection has been received (YES at step 662). In some examples, responsive to determining that an input to stop incident detection has not been received (NO at step 662), the process 600d repeats steps 652-662.

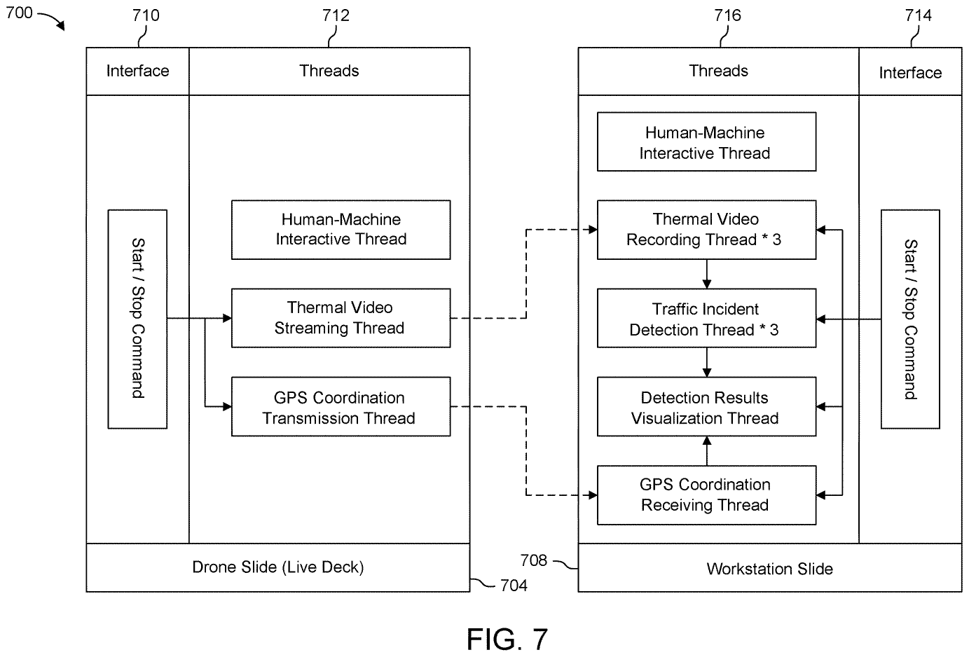

FIG. 7 illustrates an example software architecture 700 for a traffic incident detection platform, according to the present teachings. In some examples, the software architecture 700 is implemented as part of the traffic incident detection platform 216 described with reference to FIG. 2. The software architecture 700 can include drone-side or live deck side components 704 and workstation-side components 708.

The drone-side components 704 can include an interface 710 and a set of threads 712. The interface 710 of the drone-side components 704 can receive operator commands and transmit start and stop commands to the threads 712. The threads 712 of the drone-side components 704 can include a human-machine interactive thread, a thermal video streaming thread, and a GPS coordination transmission thread. The human-machine interactive thread can receive operator commands from the interface and control the initiation and termination of the thermal video streaming thread and the GPS coordination transmission thread. The thermal video streaming thread can transmit real-time thermal traffic monitoring video from the drone 104 to the livestream platform 120, enabling the system workstation 116 to access and record the live video feed. The GPS coordination transmission thread can transmit timestamped GPS coordinates received from the drone 104 directly to the system workstation 116, enabling real-time location tracking of the drone 104 throughout the detection flight.

The workstation-side components 708 can include an interface 714 and a set of threads 716. The interface 714 of the workstation-side components 708 can receive operator commands and transmit start and stop commands to the threads 716. The threads 716 of the workstation-side components 708 can include a human-machine interactive thread, three thermal video recording threads, three traffic incident detection threads, a GPS coordination receiving thread, and a detection results visualization thread. The human-machine interactive thread can receive operator commands from the interface and manage the initiation and termination of the remaining threads. The GPS coordination receiving thread can receive and store timestamped GPS coordinates transmitted by the drone-side GPS coordination transmission thread.

Each of the three thermal video recording threads can record the live-streamed thermal video from the livestream platform 120 and segment the recorded video into two-minute clips, with the three threads initiated at 40-second intervals to implement the sliding window recording scheme. Each of the three traffic incident detection threads can monitor a designated watch folder for new video segments and, upon detecting a new video segment, execute the traffic incident detection framework 212 to perform vehicle identification, trajectory image generation, TCD-Net-based incident classification, incident feature extraction, and GPS coordinate integration. The detection results visualization thread can continuously monitor the latest incident detection results and visualize the results on the web-based GUI in real time. In some examples, rather than executing the traffic incident detection framework 212 on the system workstation 116, the traffic incident detection framework 212 may be executed on one or more onboard edge computing modules mounted on the drone 104, as described herein. In such examples, the workstation-side threads may receive processed detection results transmitted from the drone 104, rather than raw video segments, and the detection results visualization thread can render the received results on the web-based GUI in real time.

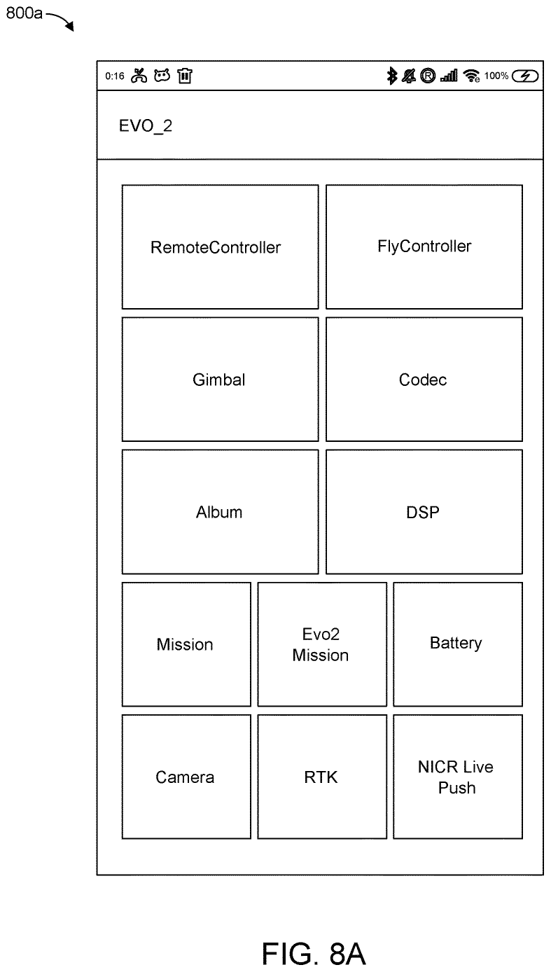

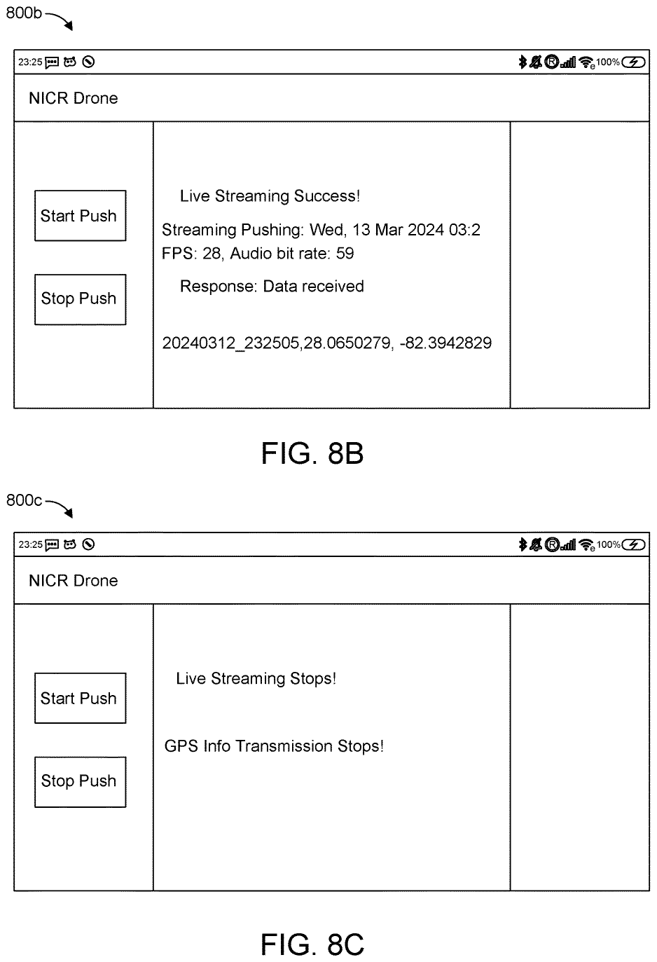

FIGS. 8A-8C illustrate example GUIs 800a-800c for drone control in a traffic incident detection system, according to the present teachings. In some examples, the GUIs 800a-800c may be generated by, for example, the traffic incident detection platform 216 described with reference to FIG. 2. The GUIs 800a-800c can be provided to the second remote controller 112, which can be implemented as an Android smart device connected to the live deck on the drone side of the system 100. In some examples, the GUIs 800a-800c can be generated by a native Android application or another operating system application executing on the second remote controller 112, and can enable an operator to control the initiation and termination of thermal video streaming and GPS data transmission from the drone 104 to the system workstation 116 and the livestream platform 120.

The GUI 800a of FIG. 8A can correspond to a main interface of the application executing on the second remote controller 112. The main interface can employ a grid layout to display a plurality of operational modules, each representing a distinct function or system component of the drone 104. The operational modules can include, for example, modules corresponding to a remote controller, a fly controller, a gimbal, a codec, an album, a digital signal processor (DSP), a mission planner, a battery status indicator, a camera, a real-time kinematic (RTK) positioning module, and a live push module. Each module can be selectable by an operator to access the corresponding function or status information. The main interface can provide an overview of the operational status of the drone 104 and its onboard systems, enabling an operator to navigate to specific functional interfaces, such as the live streaming interface, by selecting the corresponding module.

The GUI 800b of FIG. 8B can correspond to a live streaming interface of the application, accessible by selecting the live push module from the main interface of GUI 800a. The live streaming interface can display a confirmation message indicating a successful connection to the livestream platform 120, such as a “LiveStreaming Success!” status message. The live streaming interface can also display streaming parameters including the date and time of the streaming session, the frame rate of the transmitted video (e.g., frames per second), and the audio bit rate. A lower portion of the live streaming interface can display the transmission status of GPS coordinate data from the drone 104 to the system workstation 116, including the most recently transmitted timestamped GPS coordinates. The live streaming interface can include a start push control and a stop push control that enable an operator to manually initiate and terminate live streaming and GPS data transmission, respectively.

The GUI 800c of FIG. 8C can correspond to the live streaming interface of the Android application in a state in which both live streaming and GPS data transmission have been terminated. The live streaming interface in the stopped state can display status messages indicating that live streaming and GPS data transmission have ceased, such as “Live Streaming Stops!” and “GPS Info Transmission Stops!” status messages. The start push control and stop push control can remain accessible in the stopped state, enabling an operator to reinitiate live streaming and GPS data transmission as needed.

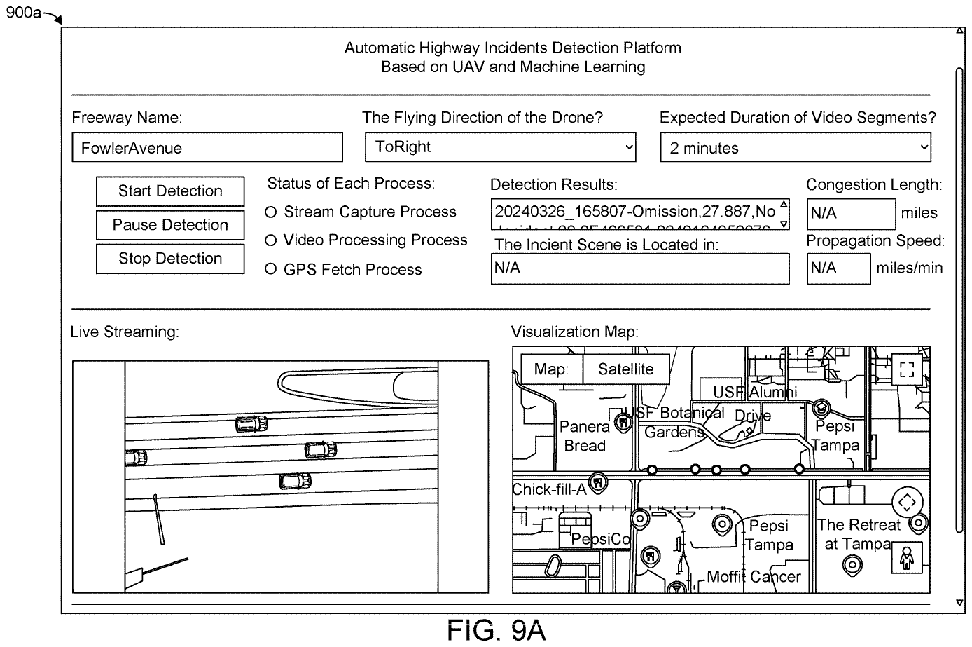

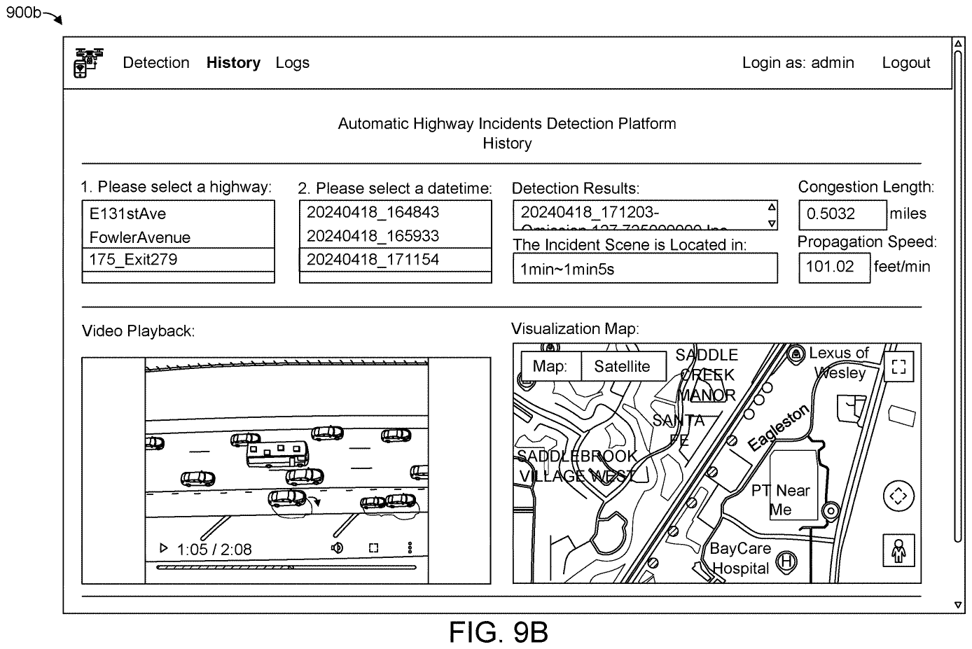

FIGS. 9A-9B illustrate example webpage GUIs 900a-900b for reviewing incident detection and traffic history in a traffic incident detection platform, according to the present teachings. In some examples, the GUIs 900a-900b may be generated by, for example, the traffic incident detection platform 216 described with reference to FIG. 2. The GUIs 900a-900b can be provided to the system workstation 116 and rendered in a web browser executing on the system workstation 116 or on any other computing device with network access to the web-based application. The GUIs 900a-900b can employ a responsive design that adapts to both desktop and mobile screen sizes.

The GUI 900a of FIG. 9A can correspond to a detection webpage of the web-based application executing on the system workstation 116. The detection webpage can include one or more input fields that enable an operator to configure detection parameters prior to initiating a detection session. The input fields can include a freeway name field for entering the name of the freeway being monitored, a drone flying direction field for specifying the direction of drone flight relative to the monitored traffic flow, and a video segment duration field for specifying the expected duration of each recorded video segment. The detection webpage can include start detection, pause detection, and stop detection controls that enable an operator to initiate, pause, and terminate the detection process, respectively. The detection webpage can include a status panel displaying the operational status of each active process, including a stream capture process, a video processing process, and a GPS fetch process.

When a process is active, the status panel can display a visual indicator (e.g., a colored dot and bold font) to distinguish active processes from inactive processes. The detection webpage can include a detection results text box that displays formatted incident detection results in real time, with items corresponding to detected traffic incidents displayed in a visually distinct format (e.g., red bold font) to draw operator attention. The detection webpage can include fields displaying the incident scene time period, the congestion length, and the congestion propagation speed extracted by the incident features extraction algorithm. The detection webpage can include a live streaming window that displays the real-time thermal video feed from the drone 104. The detection webpage can include a visualization map that displays incident detection results geolocated on an interactive map, with incident-induced congestion, recurrent congestion, and normal traffic conditions represented by color-coded markers (e.g., red, orange, and green markers, respectively).

The GUI 900b of FIG. 9B can correspond to a history review webpage of the web-based application executing on the system workstation 116. The history review webpage can enable an operator to access stored detection results from previously completed detection flights. The history review webpage can include a highway selector that displays the names of all previously monitored freeways and enables an operator to select a freeway of interest.

Responsive to selection of a freeway, a datetime selector can be populated with the dates and times of all detection sessions conducted on the selected freeway, enabling the operator to select a specific detection session for review. Responsive to selection of a detection session, a detection results text box can display the formatted incident detection results for the selected session, with items corresponding to detected traffic incidents displayed in a visually distinct format.

The history review webpage can display the incident scene time period, the congestion length, and the congestion propagation speed associated with the selected detection session. The history review webpage can include a video playback window that enables an operator to replay the thermal video segment corresponding to the selected detection session, facilitating review of the incident scene and assessment of incident type and severity. The history review webpage can include a visualization map that displays the geolocated detection results for the selected detection session on an interactive map, with color-coded markers representing incident-induced congestion, recurrent congestion, and normal traffic conditions.

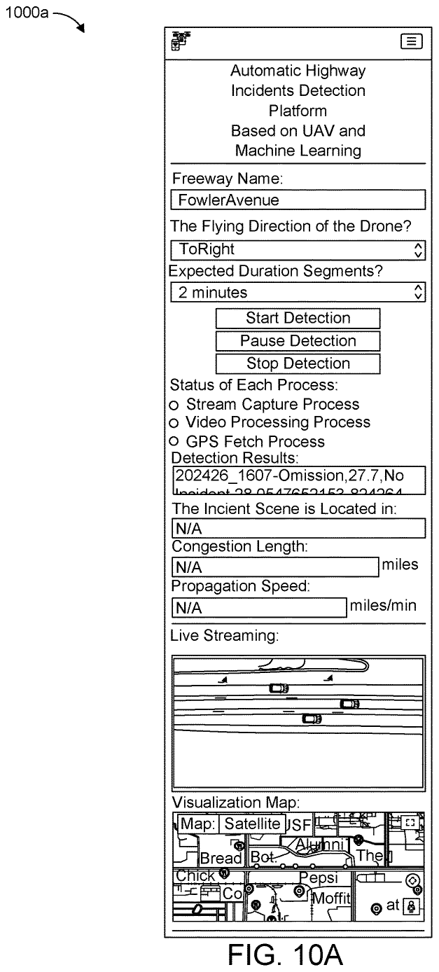

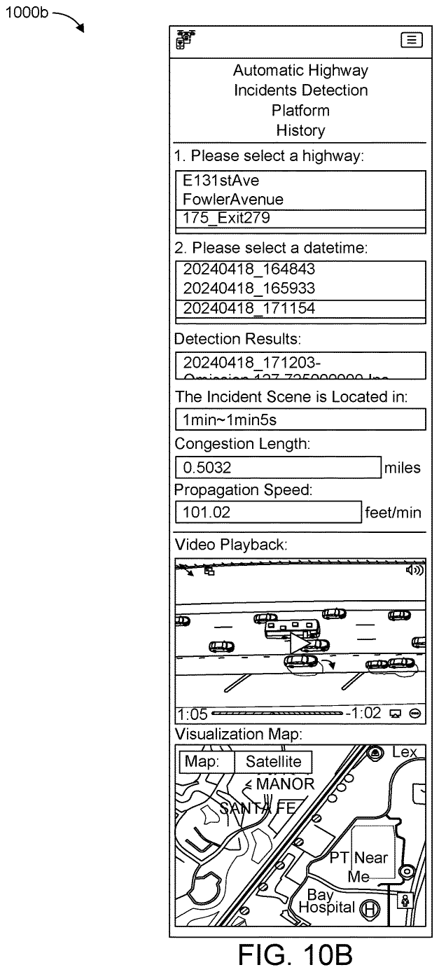

FIGS. 10A-10B illustrate example mobile device GUIs 1000a-1000b for reviewing incident detection and traffic history in a traffic incident detection platform, according to the present teachings. In some examples, the GUIs 1000a-1000b may be generated by, for example, the traffic incident detection platform 216 described with reference to FIG. 2. The GUIs 1000a-1000b can be provided to any mobile computing device, such as a smartphone or tablet computer, with network access to the web-based application. The GUIs 1000a-1000b can correspond to mobile-optimized versions of the detection webpage and history review webpage, respectively, rendered using the responsive design of the web-based application to adapt the layout and navigation controls to the screen size and form factor of mobile devices.

The GUI 1000a of FIG. 10A can correspond to a mobile-optimized version of the detection webpage described with reference to GUI 900a. The mobile detection webpage can present the same functional elements as the desktop detection webpage, including the freeway name field, drone flying direction field, video segment duration field, start detection, pause detection, and stop detection controls, process status indicators, detection results text box, incident scene time period, congestion length, congestion propagation speed, live streaming window, and visualization map. The layout of the mobile detection webpage can be adapted to the reduced screen width of mobile devices, with elements arranged in a vertically stacked configuration to enable scrolling navigation. Navigation between the detection webpage, history review webpage, and other pages of the web-based application can be accessible via a menu control (e.g., a hamburger menu icon) displayed in an upper corner of the mobile interface.

The GUI 1000b of FIG. 10B can correspond to a mobile-optimized version of the history review webpage described with reference to GUI 900b. The mobile history review webpage can present the same functional elements as the desktop history review webpage, including the highway selector, datetime selector, detection results text box, incident scene time period, congestion length, congestion propagation speed, video playback window, and visualization map. The layout of the mobile history review webpage can be adapted to the reduced screen width of mobile devices, with elements arranged in a vertically stacked configuration to enable scrolling navigation.

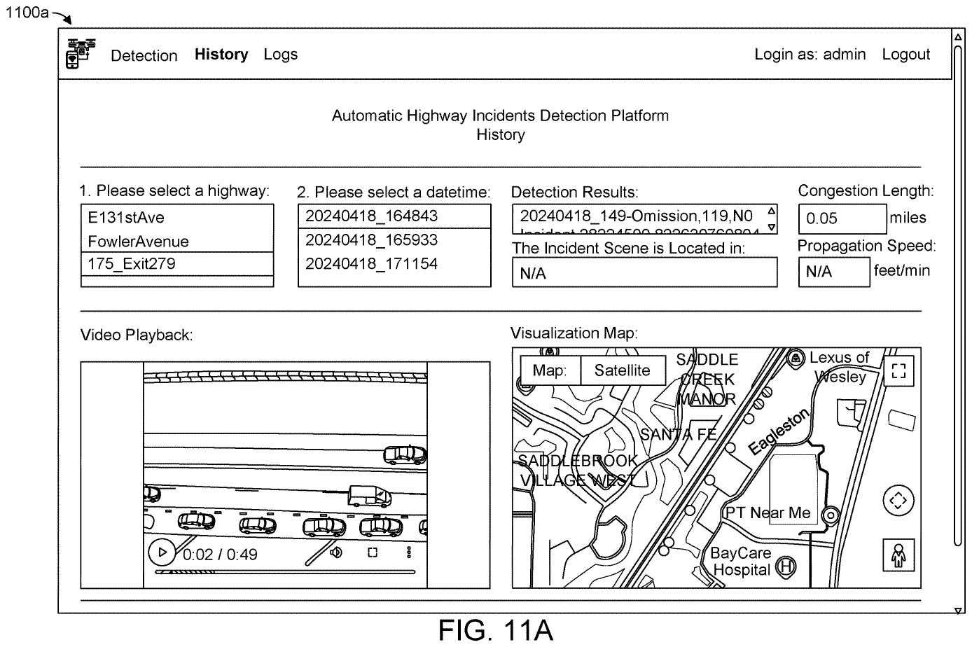

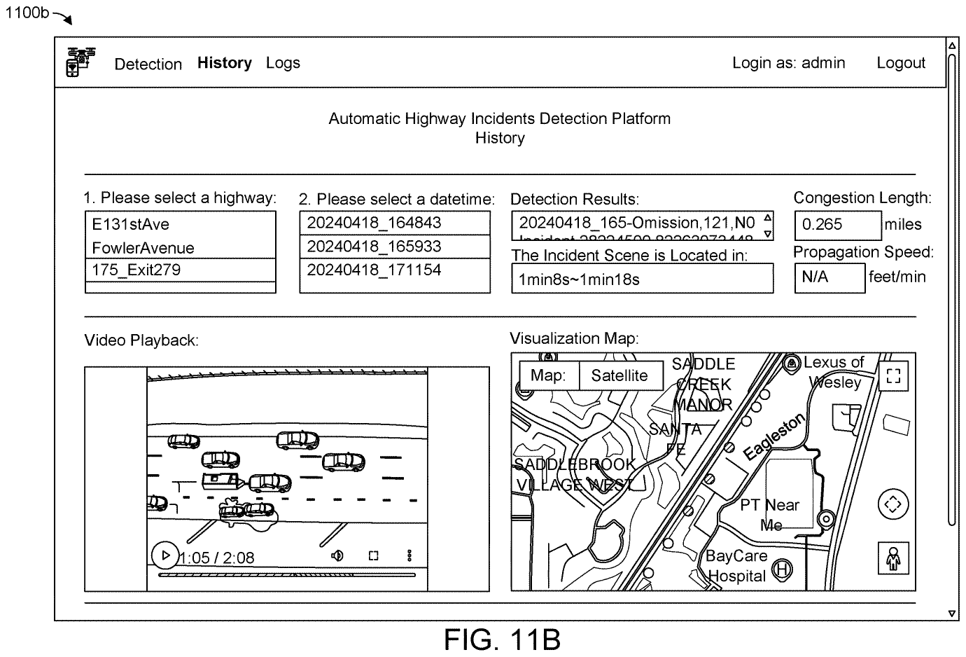

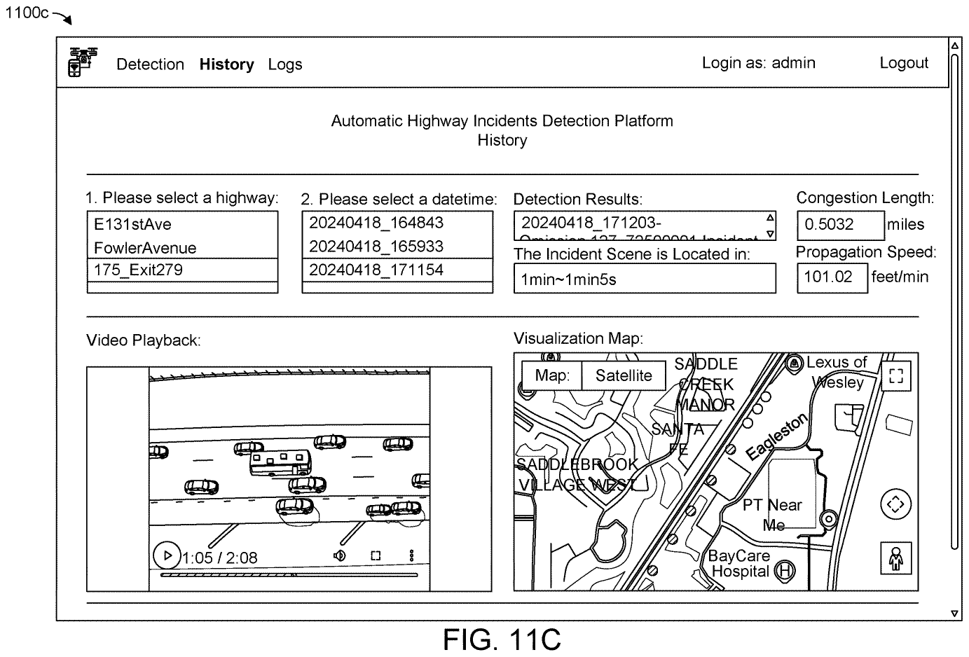

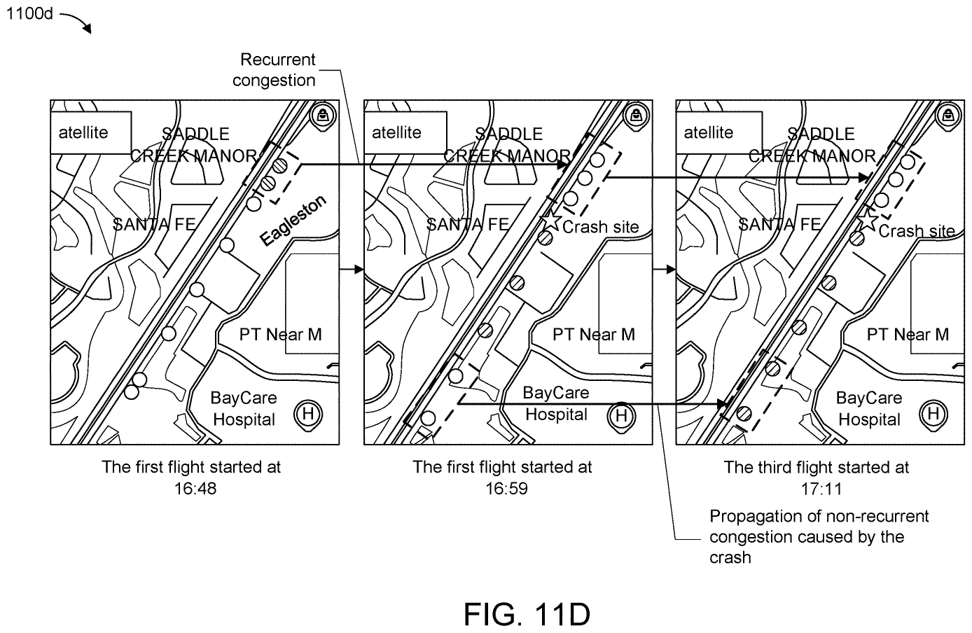

FIGS. 11A-11D illustrate example GUIs 1100a-1100d displaying traffic incident detection results from three example detection flights, according to the present teachings. In some examples, the GUIs 1100a-1100d may be generated by, for example, the traffic incident detection platform 216 described with reference to FIG. 2. The GUIs 1100a-1100d can be provided to the system workstation 116 and rendered in a web browser executing on the system workstation 116 or on any other computing device with network access to the web-based application. The GUIs 1100a-1100d can correspond to history review webpage views of detection results from three consecutive detection flights conducted during a field test on the Interstate 75 (I-75) freeway in Wesley Chapel, Florida, during which a rear-end collision occurred.

The GUI 1100a of FIG. 11A can correspond to the history review webpage displaying detection results from a first detection flight that started at 16:48. The detection results displayed in GUI 1100a can indicate that the traffic incident detection platform 216 detected a recurrent congestion pattern during the first flight. The visualization map of GUI 1100a can display detection points near the off-ramp of I-75 Exit 279, with markers indicating recurrent congestion at the off-ramp location. The detection results can indicate that the congestion detected during the first flight was concentrated at the off-ramp, downstream of which a signalized intersection exists, suggesting that the congestion was attributable to signal timing constraints rather than a traffic incident. The congestion length and propagation speed fields of GUI 1100a can display values corresponding to the recurrent congestion detected during the first flight, and the incident scene time period field can indicate that no incident scene was identified during the first flight.

The GUI 1100b of FIG. 11B can correspond to the history review webpage displaying detection results from a second detection flight that started at 16:59. The detection results displayed in GUI 1100b can indicate that the traffic incident detection platform 216 detected an incident-induced non-recurrent congestion pattern during the second flight. The visualization map of GUI 1100b can display three detection points upstream of the off-ramp labeled as indicating incident-induced congestion, while the recurrent congestion previously detected at the off-ramp during the first flight can be shown as having dissipated. The congestion length field of GUI 1100b can display a value of 0.265 miles, corresponding to the extent of the incident-induced non-recurrent congestion detected during the second flight. The incident scene time period field of GUI 1100b can display the time interval within the first upstream incident-detected video segment during which the incident scene was identified (e.g., 1 minute 8 seconds to 1 minute 18 seconds), enabling an operator to locate the incident scene using the video playback functionality. The propagation speed field of GUI 1100b can indicate that propagation speed data was not yet available, as only one flight had detected the incident at that point.

The GUI 1100c of FIG. 11C can correspond to the history review webpage displaying detection results from a third detection flight that started at 17:11. The detection results displayed in GUI 1100c can indicate that the traffic incident detection platform 216 continued to detect an incident-induced non-recurrent congestion pattern during the third flight, with all detection points upstream of the off-ramp labeled as indicating incident-induced congestion. The visualization map of GUI 1100c can display the expanded upstream propagation of the incident-induced congestion relative to the second flight, illustrating the progression of the non-recurrent congestion over time. In the example of FIG. 11C, the congestion length field of GUI 1100c can display a value of 0.5032 miles, reflecting the increased extent of the incident-induced non-recurrent congestion during the third flight. The propagation speed field of GUI 1100c can display a value of 101.02 feet per minute, calculated based on the change in congestion length between the second and third flights and the time interval between the two flights. The incident scene time period field of GUI 1100c can display the time interval within the first upstream incident-detected video segment during which the incident scene was identified (e.g., 1 minute to 1 minute 5 seconds), enabling an operator to confirm the presence, type, and severity of the traffic incident using the video playback functionality.

The GUI 1100d of FIG. 11D can correspond to a visualization depicting the propagation process of incident-induced non-recurrent congestion captured across all three detection flights during the field test. The GUI 1100d can display a composite visualization map showing the detection results from the first flight (started at 16:48), the second flight (started at 16:59), and the third flight (started at 17:11) together, enabling an operator to observe the temporal evolution and upstream propagation of the incident-induced non-recurrent congestion over the course of the detection session. The GUI 1100d can include annotations identifying the crash site location, the extent of recurrent congestion detected during the first flight, and the progressive upstream propagation of the incident-induced non-recurrent congestion detected during the second and third flights. The GUI 1100d can thereby provide TMC personnel with a comprehensive view of the spatial and temporal dynamics of the incident-induced congestion, supporting proactive traffic management decisions.

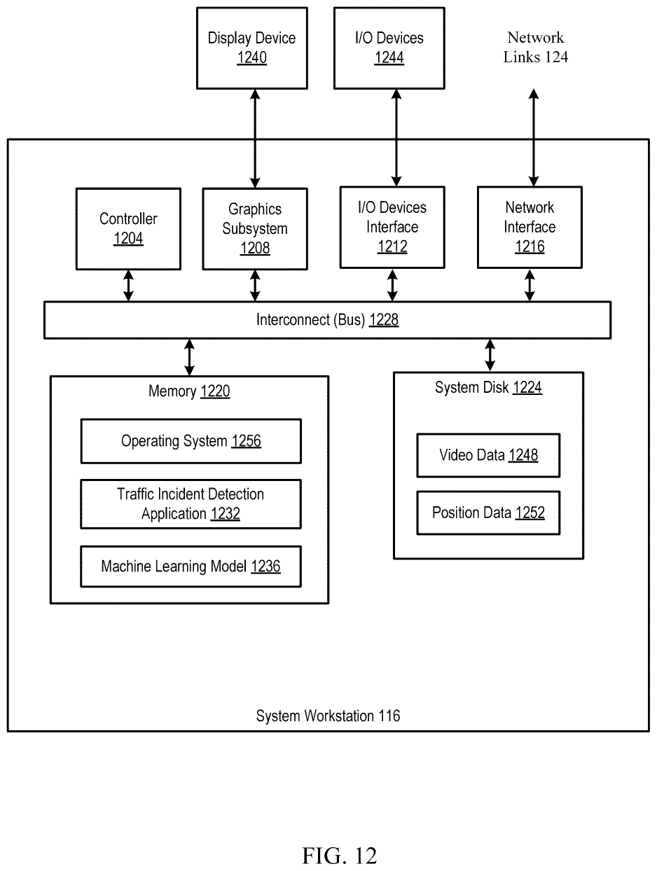

FIG. 12 is a block diagram of a system workstation 116 that may be implemented in conjunction with the computing system 100 of FIG. 1, according to present teachings. As shown in FIG. 12, the system workstation 116 can include, without limitation, at least one processor 1204, a graphics subsystem 1208, an input/output (I/O) devices interface 1212, a network interface 1216, a system memory 1220, a system disk 1224, and an interconnect 1228. The interconnect, or bus, 1228 can include one or more wires, cables, traces, contacts, analog components, digital components, wireless connection components, and/or other suitable means for interconnecting hardware components of the system workstation 116.

The processor 1204 is adapted to retrieve and execute programming instructions, such as the traffic incident detection application 1232 and/or an associated machine learning model 1236, stored in the system memory 1220. Similarly, the processor 1204 is adapted to store application data (e.g., software libraries) and retrieve application data from the memory 1220. The interconnect 1228 is adapted to facilitate transmission of data, such as programming instructions and application data, between the processor 1204, the graphics subsystem 1208, the I/O devices interface 1212, the network interface 1216, the system memory 1220, and the system disk 1224.

The processor 1204 can be a multi-core CPU, such as an Intel Core i7 or i9 series processor, an AMD Ryzen 7 or 9 series processor, or a comparable multi-core processor, capable of executing multiple concurrent threads. The traffic incident detection application 1232 can be implemented as a multi-threaded software application in which distinct threads are allocated to distinct functional tasks, including a GPS data receiving thread, a video recording thread (or a set of video recording threads corresponding to the sliding window recording scheme), a set of incident detection threads (each monitoring a respective watch folder and executing the traffic incident detection framework pipeline), and a GUI server thread. Each thread executes as a separate execution context managed by the operating system scheduler and communicates with other threads via shared data structures protected by synchronization primitives (e.g., mutexes, semaphores, or thread-safe queues). The machine learning model 1236 is a serialized representation of the TCD-Net architecture 400, stored as a model file on the system disk 1224, comprising the model architecture definition (e.g., layer types, layer configurations, and layer connectivity) and the trained numerical parameters (weight tensors and bias vectors) for each layer. During initialization of the traffic incident detection application 1232, the processor 1204 loads the model file from the system disk 1224 into the system memory 1220, instantiates the model architecture, transfers the model parameters to the GPU memory of the graphics subsystem 1208, and places the model in inference mode. During inference, the processor 1204 transfers input trajectory image tensors from the system memory 1220 to the GPU memory, invokes GPU-accelerated forward-pass computations through the model layers, and retrieves the output classification results from the GPU memory back to the system memory 1220 for subsequent processing by the image-to-video aggregation and incident feature extraction routines.

In some embodiments, the graphics subsystem 1208 is adapted to generate one or more GUIS associated with the traffic incident detection application 1232 and transmit the GUIs to display device 1240. In some embodiments, the graphics subsystem 1208 is adapted to generate one or more frames of image and/or video data and transmit the frames of image and/or video data to display device 1240. In some embodiments, the graphics subsystem 1208 may be integrated into an integrated circuit, along with the processor 1204. The display device 1240 may comprise any technically feasible means for generating an image for display. For example, the display device 1240 may be fabricated using liquid crystal display (LCD) technology, cathode-ray technology, and light-emitting diode (LED) display technology. The display device 1240 may include, for example, one or more monitors.

The I/O devices interface 1212 is adapted to receive input data from I/O devices 1244 and transmit the input data to the processor 1204 via the interconnect 1228. For example, I/O devices 1244 may include one or more buttons, a keyboard, a mouse, and/or other input devices. The I/O devices interface 1212 is further adapted to receive output data from the processor 1204 via the interconnect 1228 and transmit the output data to the I/O devices 1244.

The system disk 1224 may include one or more hard disk drives, solid state storage devices, or similar storage devices. The system disk 1224 is configured to store non-volatile data such as files (e.g., audio files, video files, subtitles, application files, software libraries, etc.). As shown in FIG. 12, the system disk 1224 can be further configured to store video data captured by the drone 104 and position data 1252 associated with a position of the drone 104 during video capture.

In some examples, the system 100 employs specific data structures to store and communicate information between the functional components described herein. The GPS coordinate data structure can be a table or list in which each record comprises the following fields: a timestamp field storing a floating-point Unix epoch value representing the date and time at which the GPS coordinate was recorded, expressed as the number of seconds elapsed since Jan. 1, 1970, 00:00:00 UTC; a latitude field storing a floating-point decimal degrees value representing the geographic latitude of the drone 104 at the recorded timestamp, with positive values indicating north latitude and negative values indicating south latitude; and a longitude field storing a floating-point decimal degrees value representing the geographic longitude of the drone 104 at the recorded timestamp, with positive values indicating east longitude and negative values indicating west longitude. The GPS coordinate data structure can be stored in the system memory 1220 or on the system disk 1224 of the system workstation 116 as a relational database table (e.g., an SQLite or PostgreSQL table), a comma-separated values (CSV) file, or an in-memory data structure (e.g., a Python list of dictionaries, a Pandas DataFrame, or a NumPy structured array). The detection results data structure can be a table or list in which each record comprises the following fields: a segment_id field storing a unique identifier for the video segment to which the detection result corresponds; a classification_label field storing an integer value representing the video-level traffic condition classification (e.g., 0 for normal traffic, 1 for recurrent congestion, 2 for incident-induced non-recurrent congestion); a detection_timestamp field storing a floating-point Unix epoch value representing the date and time at which the detection result was produced; an incident_latitude field storing a floating-point decimal degrees value representing the geographic latitude of the detected incident site, or a null value if no incident was detected; an incident_longitude field storing a floating-point decimal degrees value representing the geographic longitude of the detected incident site, or a null value if no incident was detected; a congestion_length_meters field storing a floating-point value representing the computed length of incident-induced non-recurrent congestion in meters, or a null value if no incident was detected; and a propagation_speed_mps field storing a floating-point value representing the computed congestion propagation speed in meters per second, or a null value if propagation speed data is not yet available. The detection results data structure can be stored in the system memory 1220 or on the system disk 1224 of the system workstation 116 as a relational database table, a JSON file, or an in-memory data structure, and can be accessed by the traffic incident detection platform 216 to populate the web-based GUI with real-time and historical detection results.

The system memory 1220 can include programming instructions and application data that comprise an operating system 1256, a traffic incident detection application 1232, and a machine learning model 1236 invoked by the traffic incident detection application 1232. The processor 1204 can implement the traffic incident detection application to receive sensor data (e.g., video data) from the drone 104, for example, via the live deck 112, and perform traffic incident detection based on the received sensor data.

The traffic incident detection application 1232 stored in the system memory 1220 can comprise a set of Python scripts or compiled binaries that import and utilize specific software libraries, including: a deep learning framework library (e.g., PyTorch or TensorFlow) for defining, loading, and executing the TCD-Net model; a computer vision library (e.g., OpenCV) for video decoding, frame extraction, image manipulation, object detection inference, optical flow computation, and image rendering; a numerical computation library (e.g., NumPy) for array operations, coordinate transformations, and arithmetic computations; a data manipulation library (e.g., Pandas) for managing GPS coordinate tables and detection result records; and a web framework library (e.g., Django or Flask) for serving the web-based GUI. The machine learning model 1236 stored in the system memory 1220 comprises the instantiated TCD-Net model object, including the model architecture graph and the trained parameter tensors loaded from the serialized model file on the system disk 1224. The YOLO vehicle detection model used by the traffic incident detection framework can be stored as a separate model file on the system disk 1224, comprising the YOLO network architecture definition and the custom-trained weight parameters optimized for thermal vehicle detection, and can be loaded into the system memory 1220 and the GPU memory during initialization of the traffic incident detection application 1232. The Lucas-Kanade optical flow algorithm used for vehicle trajectory tracking is implemented using the OpenCV calcOpticalFlowPyrLK function, which computes sparse optical flow vectors by solving the Lucas-Kanade equations at each tracked feature point across a pyramid of image resolutions, producing per-frame displacement vectors for each tracked vehicle centroid. The motion compensation algorithm is implemented as a sequence of arithmetic operations that compute, for each video frame, a displacement offset based on the product of the drone ground speed (derived from consecutive GPS coordinates using the Haversine formula or Euclidean distance divided by the time interval between GPS samples) and the elapsed time since the start of the video segment, and subtract the computed offset from the vehicle centroid coordinates to yield motion-compensated trajectory coordinates.

In some examples, in implementing the traffic incident detection application 1232, the system workstation 116 can receive thermal video data from the livestream platform 120 via the network interface 1216 and segment the received video data into discrete two-minute video segments using a sliding window recording scheme. The system workstation 116 can apply the machine learning model 1236 to vehicle trajectory images extracted from each video segment to classify each trajectory image as indicating normal traffic, recurrent congestion, or incident-induced non-recurrent congestion. The system workstation 116 can aggregate the image-level classification results for each video segment to produce a video-level incident detection result, extract incident features including the incident scene time period, congestion length, and congestion propagation speed, and integrate GPS coordinate data received from the drone 104 to geolocate the detection results. The system workstation 116 can transmit the geolocated detection results to the web-based GUI for real-time visualization.

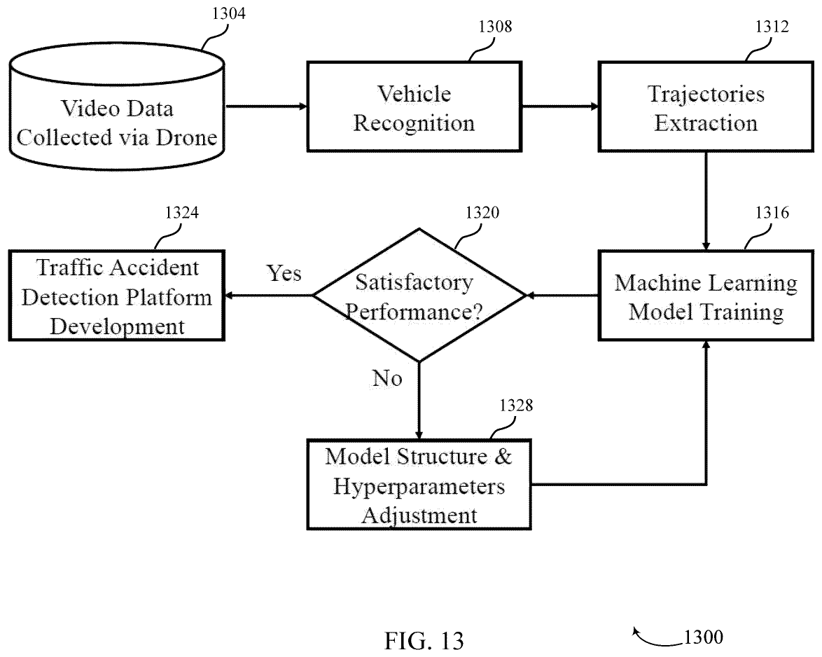

FIG. 13 illustrates an example process 1300 for training a machine learning model 1236 implemented in conjunction with the system 100 of FIG. 1, according to the present teachings. The machine learning model 1236 can be a CNN-based model implemented as described with reference to FIG. 4.

At step 1304, the process 1300 can include receiving video data collected from a drone 104. The video data can include thermal traffic monitoring video captured by the drone 104 during freeway patrol operations under various traffic conditions, including normal traffic conditions, recurrent congestion conditions, and traffic incident conditions. In some examples, the video data can include a plurality of thermal video clips of varying durations, captured from multiple freeway locations and encompassing diverse traffic scenarios to enable training of a robust and generalizable machine learning model 1236.

At step 1308, the process 1300 can include performing vehicle recognition with respect to the received video data. The vehicle recognition can include applying a YOLO model with custom-trained weights to each frame of the received video data to identify vehicles present in the frame and extract the center point coordinates of each identified vehicle. In some examples, the YOLO model can be retrained using manually annotated vehicle bounding boxes from a self-collected thermal video dataset to obtain adapted weight parameters optimized for thermal imagery, thereby improving vehicle detection accuracy for thermal traffic monitoring video.

At step 1312, the process 1300 can include performing trajectories extraction with respect to the detected vehicles. The trajectories extraction can include applying a Lucas-Kanade optical flow tracker to the vehicle coordinate data output by the vehicle recognition step to track the movement of each vehicle centroid across consecutive video frames, generating coordinate sequences that record vehicle movement. Motion compensation can be applied to the coordinate sequences to remove the effect of drone movement, based on the drone speed as derived from GPS coordinate data and the timestamps of each video frame.

At step 1316, the process 1300 can include training the machine learning model 1236 based on the extracted trajectories. Each trajectory image can be assigned a label based on the traffic condition present during the corresponding extraction period. For example, a label of 2 can be assigned for images extracted during a traffic incident period, a label of 1 can be assigned for images extracted during a recurrent congestion period, and a label of 0 can be assigned for images extracted during a normal traffic period. Stratified sampling can be applied to partition the labeled trajectory image dataset into training, validation, and test sets in a ratio of 6:2:2, with the proportion of each label maintained consistently across the three sets. The machine learning model 1236 can be trained using the training set, with an early stopping mechanism applied to terminate training if the validation loss does not improve for a predetermined number of consecutive epochs beyond the minimum validation loss, and the model parameters corresponding to the minimum validation loss can be retained.

In some examples, the TCD-Net training algorithm comprises the following operations. A training dataset can be assembled comprising labeled trajectory images, each image assigned one of three class labels: label 0 for normal traffic, label 1 for recurrent congestion, and label 2 for incident-induced non-recurrent congestion, based on the traffic condition present during the extraction time period from which the trajectory image was generated. Stratified sampling can be applied to partition the labeled dataset into training, validation, and test sets in a ratio of 6:2:2, maintaining the proportion of each class label consistently across all three sets to prevent class imbalance from affecting evaluation. The weight parameters of all convolutional layers and fully connected layers of the TCD-Net can be initialized using Xavier initialization (also referred to as Glorot initialization) or Kaiming initialization (also referred to as He initialization), which sets initial weight values by sampling from a distribution with variance scaled as a function of the number of input and output connections of each layer, and all bias parameters can be initialized to zero. The TCD-Net can be trained using mini-batch stochastic gradient descent with backpropagation, in which at each training iteration a mini-batch of trajectory images is sampled from the training set, a forward pass is executed through the TCD-Net to produce predicted SoftMax probability distributions over the three classes, the cross-entropy loss is computed between the predicted probability distributions and the ground-truth one-hot label vectors for each image in the mini-batch, the gradient of the cross-entropy loss with respect to all trainable parameters is computed by backpropagation through the TCD-Net, and the trainable parameters are updated by the Adam optimizer or the SGD optimizer with momentum using the computed gradients and a predefined learning rate. An early stopping mechanism can be applied that monitors the validation loss at the end of each training epoch and terminates training if the validation loss does not decrease below the minimum validation loss observed during training for a predefined number of consecutive epochs (the early stopping patience), retaining the model parameter values corresponding to the minimum validation loss as the final trained model. The trained model can be evaluated on the test set using evaluation metrics including loss, accuracy, precision, recall, F1-score, and Area Under the Receiver Operating Characteristic Curve (AUC-ROC), and the model trained using the combination of image mode (monochrome or color) and trajectory extraction time period that achieves the highest performance across all evaluation metrics on the test set can be selected for deployment.

At step 1320, the process 1300 can include determining whether a performance of the machine learning model 1236 is satisfactory. The performance of the machine learning model 1236 can be evaluated using one or more evaluation metrics applied to the test set, including loss, accuracy, precision, recall, F1-score, and/or Area Under the Receiver Operating Characteristic Curve (AUC-ROC). In some examples, the performance can be considered satisfactory when the machine learning model 1236 achieves a predetermined accuracy threshold on the test set. In some examples, the machine learning model 1236 trained using monochrome trajectory images and a predefined extraction time period (e.g., a 20 second extraction time period) can be selected for deployment based on achieving superior performance across all evaluation metrics relative to models trained using other combinations of image mode and extraction time period.

At step 1324, responsive to determining that the performance of the machine learning model 1236 is satisfactory (YES at step 1320), the process 1300 can include deploying the trained machine learning model 1236 to the traffic incident detection platform 216. The trained machine learning model 1236 can be integrated into the traffic incident detection application 1232 of the system workstation 116 for use in real-time incident detection. The trajectory extraction time period and image mode corresponding to the optimal machine learning model 1236 can be adopted as the standard configuration for vehicle trajectory image generation during deployment of the traffic incident detection platform 216.

At step 1328, the process 1300 can include, responsive to determining that the performance of the machine learning model 1236 is not satisfactory (NO at step 1320), adjusting the structure and/or hyperparameters of the machine learning model 1236. Adjustments to the structure of the machine learning model 1236 can include modifying the number or sizes of convolutional kernels in the Multiscale CNN module, the number of stacked feature extraction layers, the number of nodes in the fully connected dense layers, and/or the configuration of the CBAM or SPP modules. Adjustments to the hyperparameters of the machine learning model 1236 can include modifying the learning rate, the dropout rate, the batch size, the early stopping patience, the vehicle trajectory extraction time period, and/or the image mode used for trajectory image generation. Following adjustment, the process 1300 can return to step 1316 to retrain the machine learning model 1236 using the adjusted structure and/or hyperparameters.

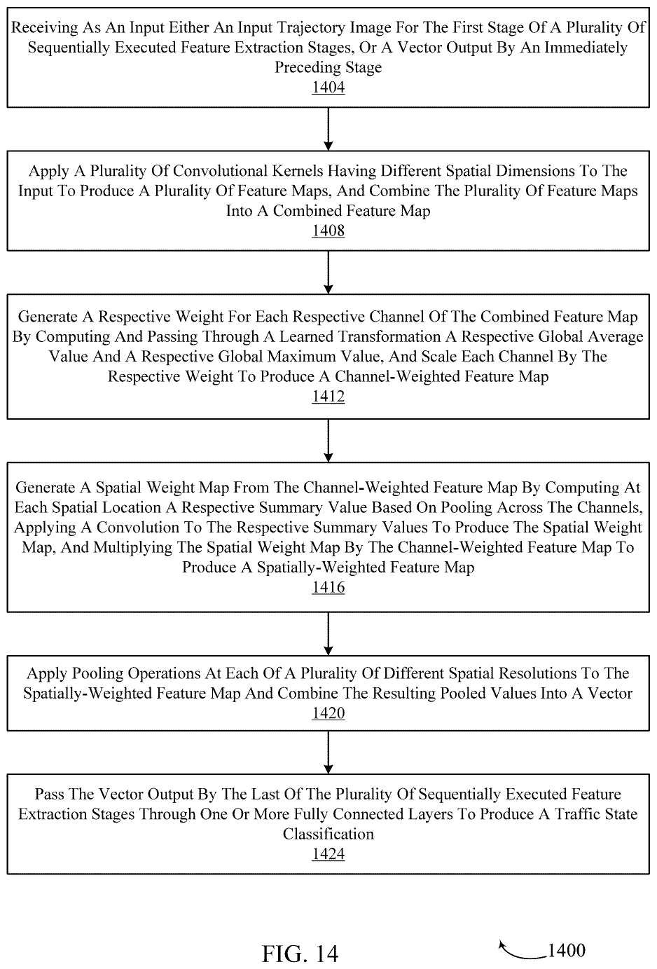

FIG. 14 is a flow diagram of a process 1400 for UAV-based traffic incident detection, according to the present teachings. Although the method steps are described with reference to the systems and processes of FIGS. 1-13, persons skilled in the art will understand that any system adapted to implement the method steps, in any order, falls within the scope of the present invention. In some examples, at least one objective of the process 1400 is to classify a traffic state represented in an input trajectory image as one of a plurality of traffic condition classes. Classifying the traffic state can include a plurality of sequentially executed feature extraction stages.

At step 1404, some or all of the stages can include receiving as an input either the input trajectory image for the first stage of the plurality of sequentially executed feature extraction stages, or a vector output by an immediately preceding stage. For example, the system workstation 116 can receive, via the data ingestion module 404 of the TCD-Net architecture 400 described with reference to FIG. 4, a vehicle trajectory image generated during the trajectory image generation step 228 described with reference to FIG. 2, or can receive a fixed-length feature vector output by the SPP module 424 of an immediately preceding layer of the feature extraction module 408.

At step 1408, some or all of the stages can include applying a plurality of convolutional kernels having different spatial dimensions to the input to produce a plurality of feature maps. For example, the system workstation 116 can apply the multiscale CNN module 418 of the feature extraction module 408 described with reference to FIG. 4, which applies convolutional kernels of sizes 1×1, 1×3, 1×5, and 3×3 to capture features at multiple scales corresponding to different vehicle trajectory characteristics.

Continuing with step 1408, some or all of the stages can further include combining the plurality of feature maps into a combined feature map. For example, the system workstation 116 can concatenate the plurality of feature maps produced by the respective convolutional kernels of the multiscale CNN module 418 along the channel dimension and apply a 1×1 convolution to fuse the multi-scale feature representations into the combined feature map, as described with reference to FIG. 4.

At step 1412, some or all of the stages can include generating a respective weight for each respective channel of the combined feature map by computing and passing through a learned transformation a respective global average value and a respective global maximum value. For example, the system workstation 116 can apply the channel attention module 428 of the CBAM 420 described with reference to FIG. 4, which applies global average pooling and global max pooling across each channel and passes the pooled outputs through a shared MLP to generate a channel attention map that reweights each channel according to its importance to the classification task.

Continuing with step 1412, some or all of the stages can further include scaling each channel by the respective weight to produce a channel-weighted feature map. For example, the system workstation 116 can apply the channel attention map generated by the channel attention module 428 of the CBAM 420 described with reference to FIG. 4 to reweight each channel of the combined feature map, producing a channel-refined feature map that emphasizes the most informative channels for the classification task.

At step 1416, some or all of the stages can include generating a spatial weight map from the channel-weighted feature map by computing at each spatial location a respective summary value based on pooling across the channels, applying a convolution to the respective summary values to produce the spatial weight map, and multiplying the spatial weight map by the channel-weighted feature map to produce a spatially-weighted feature map. For example, the system workstation 116 can apply the spatial attention module 432 of the CBAM 420 described with reference to FIG. 4, which receives the channel-refined feature map, applies average pooling and max pooling along the channel dimension, passes the concatenated results through a convolutional layer to produce the spatial weight map, and element-wise multiplies the spatial weight map with the channel-weighted feature map to produce a spatially-weighted feature map that emphasizes the most relevant spatial locations.

At step 1428 some or all of the stages can include applying pooling operations at each of a plurality of different spatial resolutions to the spatially-weighted feature map and combine the resulting pooled values into a vector. For example, the system workstation 116 can apply the SPP module 424 described with reference to FIG. 4, which performs pooling at multiple spatial scales, such as 1×1, 2×2, and 4×4, and flattens and concatenates the pooled outputs into a fixed-length feature vector for processing by subsequent layers.

At step 1424, the process 1400 can include passing the vector output by the last of the plurality of sequentially executed feature extraction stages through one or more fully connected layers to produce a traffic state classification. For example, the system workstation 116 can pass the fixed-length feature vector output by the final layer of the feature extraction module 408 through the fully connected dense layers and dropout module 412 and the classification module 416 of the TCD-Net architecture 400 described with reference to FIG. 4, which progressively reduce the dimensionality of the extracted features and map the resulting compressed representation to one of the plurality of traffic condition classes.

In some examples, the process 1400 can include generating an alert indicating detection of a traffic incident responsive to classifying the traffic state as incident-induced non-recurrent congestion. For example, the system workstation 116 can generate an alert signal responsive to the traffic state classification produced at step 1424 indicating incident-induced non-recurrent congestion, and can transmit the alert signal to the traffic incident detection platform 216 described with reference to FIG. 2 for display to TMC personnel via the web-based GUI.

In some examples, the process 1400 can include, responsive to detecting the traffic incident, extracting a set of incident features comprising at least one of a time period of the incident, a congestion length associated with the incident, or a congestion propagation speed associated with the incident. For example, the system workstation 116 can perform the incident features extraction step 240 described with reference to FIG. 2 to determine the time period, congestion length, and congestion propagation speed associated with the detected traffic incident.

In some examples, extracting the time period of the incident can include identifying, within a last video segment of a sequence of consecutively incident-classified video segments, a longest consecutive sequence of trajectory images classified as indicating incident-induced non-recurrent congestion, and computing the time period of the incident as a time interval corresponding to the longest consecutive sequence. For example, the system workstation 116 can determine that the incident scene falls within the last incident-classified video segment in a sequence of consecutively incident-classified segments from the same detection flight, and can identify the specific time interval covered by the longest consecutive sequence of trajectory images classified as incidents within that segment, since vehicles closest to the incident may exhibit the most frequent lane-changing behavior, the slowest speeds, and the highest density.

In some examples, extracting the congestion length can include receiving timestamped position data from an unmanned aerial vehicle at predefined intervals during a detection flight, estimating, based on the timestamped position data and a duration of each video segment, a spatial range covered by each video segment, and calculating the congestion length based on a cumulative spatial range spanned by a sequence of consecutively incident-classified video segments within the detection flight. For example, the system workstation 116 can access GPS coordinates transmitted by the drone 104 at predefined intervals and stored by the GPS information receiving process, estimate the spatial range covered by each video segment based on the GPS coordinate data and the segment duration, and calculate the total length of incident-induced non-recurrent congestion based on the cumulative GPS coordinate range spanned by consecutively incident-classified video segments within the detection flight.

In some examples, extracting the congestion propagation speed can include determining a change in congestion length between a first detection flight and a second detection flight of the unmanned aerial vehicle, each of the first and second detection flights associated with the detected traffic incident, and computing the congestion propagation speed as a rate of change of the congestion length over a time interval between the first detection flight and the second detection flight. For example, the system workstation 116 can compare the congestion length calculated during a current detection flight with the congestion length calculated during a prior detection flight that also detected the same traffic incident, and can compute the propagation speed as the difference in congestion length divided by the elapsed time between the two detection flights.

In some examples, the process 1400 can include outputting at least one signal to render, on a graphical user interface, a visualization map displaying geolocated incident detection results, wherein incident-induced non-recurrent congestion, recurrent congestion, and normal traffic conditions are represented by distinguishable markers on the visualization map. The graphical user interface can further display a live video stream from the unmanned aerial vehicle and formatted detection results indicating the traffic state classification. For example, the system workstation 116 can transmit the geolocated incident detection results to the web-based GUI of the traffic incident detection platform 216 described with reference to FIG. 2, which can render the results on an interactive visualization map using color-coded markers, such as red markers for incident-induced non-recurrent congestion, orange markers for recurrent congestion, and green markers for normal traffic conditions. The web-based GUI can simultaneously display the real-time thermal video stream from the drone 104 in a live streaming window and the formatted detection results in a dedicated text box, enabling TMC personnel to verify and monitor incidents in real time.

Prior art traffic monitoring systems suffer from a set of specific, concrete technical deficiencies that the disclosed system is designed to overcome. Fixed-infrastructure sensor-based systems, including inductive loop detectors, magnetometers, and microwave radar arrays, require high-density physical deployment along monitored roadway segments and are incapable of dynamic repositioning in response to changing traffic conditions or incident locations. Because these sensors are stationary, changes in traffic flow parameters caused by an upstream incident must propagate physically through the traffic stream before reaching a sensor location, introducing inherent detection latency that is a direct function of the spatial gap between the incident site and the nearest sensor. Stationary closed-circuit television (CCTV) camera systems, while enabling visual assessment of incident severity, are similarly constrained to fixed fields of view and require dense deployment to achieve adequate spatial coverage. Visible-light RGB cameras used in both CCTV systems and dashcam-equipped floating vehicles exhibit degraded detection performance under low-visibility conditions, including nighttime operation and adverse weather conditions such as fog, rain, and snow, because these conditions reduce the optical contrast between vehicles and the road surface in the visible-light spectrum. Furthermore, visible-light cameras capture identifiable personal information, including license plate numbers and driver faces, raising privacy concerns that constrain deployment and data retention. Existing drone-based approaches for traffic incident management have primarily addressed post-incident investigation and three-dimensional scene reconstruction rather than real-time detection, and have not provided integrated systems for real-time incident detection, online visual verification, and congestion propagation monitoring from an aerial platform.

The disclosed system provides a specific technical solution to the foregoing deficiencies through a combination of seven integrated technical elements, each addressing a distinct technical limitation of prior art systems. First, the UAV aerial platform provides mobile, dynamically repositionable coverage of freeway corridors, enabling the system to patrol extended roadway segments and to position the imaging device directly over an incident site without requiring pre-deployed fixed infrastructure. Second, thermal imaging replaces visible-light imaging as the primary sensing modality, exploiting the temperature differential between vehicle surfaces and the road surface to maintain robust vehicle detection performance at night and in adverse weather conditions, and producing imagery that does not capture identifiable personal information. Third, GPS-based motion compensation is applied to vehicle centroid coordinate sequences to subtract the apparent vehicle movement artifacts introduced by the translational movement of the drone along the freeway corridor, yielding motion-compensated trajectory coordinate sequences that accurately represent actual vehicle movement relative to the road surface. Fourth, trajectory image generation converts the motion-compensated centroid coordinate sequences into two-dimensional trajectory images that encode microscopic traffic features, including individual vehicle trajectory lengths, lane-changing frequency, and vehicle density distributions, in a spatial format suitable for processing by a convolutional neural network. Fifth, the TCD-Net deep learning architecture, comprising multiscale CNN modules with convolutional kernels of sizes 1×1, 1×3, 1×5, and 3×3, Convolutional Block Attention Modules (CBAM), and Spatial Pyramid Pooling (SPP) modules, extracts and classifies these microscopic traffic features to distinguish normal traffic, recurrent congestion, and incident-induced non-recurrent congestion. Sixth, a threshold-based image-to-video aggregation algorithm aggregates image-level classification results across all trajectory images within a video segment to produce a robust video-level incident detection result that mitigates the influence of isolated misclassifications. Seventh, GPS-integrated incident feature extraction computes the incident scene time period, the length of incident-induced non-recurrent congestion, and the congestion propagation speed by integrating timestamped GPS coordinate data with the video-level classification results, enabling real-time geolocation and quantification of detected incidents.

Each architectural element of the TCD-Net provides a specific technical benefit that is directly tied to the characteristics of the vehicle trajectory image classification problem. The multiscale CNN module applies four parallel convolutional kernels of sizes 1×1, 1×3, 1×5, and 3×3 simultaneously to each input feature map. The 1×1 kernel detects point features corresponding to stationary or near-stationary vehicles, which are characteristic of incident-induced congestion immediately adjacent to an incident site. The 1×3 kernel captures short trajectory features corresponding to vehicles traveling at slow speeds, which are characteristic of congestion conditions upstream of an incident. The 1×5 kernel captures longer trajectory patterns corresponding to vehicles traveling at higher speeds, which are characteristic of normal traffic conditions. The 3×3 kernel extracts lane-changing features, which are characteristic of vehicles maneuvering around an incident site. By applying all four kernels in parallel and fusing the resulting feature maps, the multiscale CNN module simultaneously captures traffic features at multiple spatial scales that correspond to distinct traffic behavioral patterns, enabling the model to distinguish traffic conditions that differ in vehicle speed, density, and lane-changing frequency. The CBAM attention mechanism provides a specific technical benefit by adaptively recalibrating intermediate feature maps to suppress uninformative background regions of the trajectory image and to amplify discriminative trajectory features that are most relevant to the classification task. The channel attention module of the CBAM identifies which feature map channels encode the most discriminative traffic features, and the spatial attention module identifies which spatial regions of the feature map contain the most relevant trajectory information, enabling the model to focus computational resources on the most informative portions of the input. The SPP module provides a specific technical benefit by performing pooling at three spatial resolutions (1×1, 2×2, and 4×4) and concatenating the pooled outputs into a fixed-length feature vector, thereby preserving multi-resolution spatial distribution information about vehicle trajectories that would be lost by single-scale pooling operations. The progressive dimensionality reduction performed by the four fully connected dense layers, with node counts of 2688, 1024, 256, and 64, respectively, provides a specific technical benefit by compressing the high-dimensional feature representation produced by the feature extraction module into a lower-dimensional representation that captures the most discriminative features for classification, while dropout regularization applied between the dense layers reduces overfitting during training and improves generalization to unseen traffic conditions.

Thermal imaging provides specific technical advantages over visible-light imaging that are directly relevant to the traffic incident detection application. Thermal cameras detect infrared radiation emitted by objects as a function of their surface temperature, rather than detecting reflected visible-light radiation. Vehicle surfaces, including engine compartments, exhaust systems, tires, and body panels, emit infrared radiation at temperatures that differ measurably from the temperature of the road surface, producing a high vehicle-to-background thermal contrast that enables robust vehicle detection by the YOLO model regardless of ambient lighting conditions. This thermal contrast is maintained at night, when the absence of ambient visible-light illumination renders visible-light cameras ineffective without supplemental lighting, and in adverse weather conditions such as fog and rain, which attenuate visible-light radiation but have a comparatively smaller effect on thermal infrared radiation in the wavelength bands detected by thermal cameras. The use of thermal imaging therefore eliminates the detection performance degradation that visible-light camera systems experience under low-visibility conditions, which is a specific technical improvement to the vehicle detection capability of the system. Additionally, thermal cameras do not capture the fine spatial detail required to resolve license plate characters or facial features, because the spatial resolution of thermal cameras is typically lower than that of visible-light cameras and because license plates and faces do not produce distinctive thermal signatures. The use of thermal imaging therefore provides a privacy-preserving imaging modality that avoids the capture of identifiable personal information, which is a specific technical advantage over visible-light camera systems in traffic monitoring applications.

GPS-based motion compensation addresses a specific technical problem that is unique to aerial traffic monitoring platforms and that does not arise in fixed-camera traffic monitoring systems. When the drone 104 is cruising along a freeway corridor while capturing video, the translational movement of the drone introduces an apparent displacement of all objects in the video frame, including vehicles, relative to the image coordinate system. If this drone-induced apparent displacement is not corrected, the vehicle centroid coordinate sequences recorded by the Lucas-Kanade optical flow tracker will reflect the superposition of actual vehicle movement and drone-induced apparent movement, producing trajectory coordinate sequences that do not accurately represent the actual movement of vehicles relative to the road surface. When these uncorrected coordinate sequences are rendered into trajectory images, the resulting images will contain trajectory artifacts that do not correspond to actual vehicle behavior, corrupting the microscopic traffic features that the TCD-Net relies upon for classification. GPS-based motion compensation addresses this problem by retrieving the GPS coordinate records transmitted by the drone 104 at predefined intervals, computing the ground distance between consecutive GPS records using the Haversine formula, computing the instantaneous drone ground speed as the computed distance divided by the time interval between GPS records, computing a per-frame cumulative displacement offset from the start of the extraction time period by multiplying the drone ground speed by the elapsed time and converting the result to a pixel offset using an altitude-derived scale factor, and subtracting the computed per-frame offset vector from each vehicle centroid coordinate in each frame. This compensation procedure is a specific algorithmic solution to a technical problem that is inherent to the aerial platform architecture of the disclosed system and that has no counterpart in fixed-camera traffic monitoring systems, in which the camera position is stationary and no drone-induced apparent vehicle movement artifacts are present.

The combination of the UAV aerial platform, thermal imaging, GPS-based motion compensation, trajectory image generation, TCD-Net deep learning architecture, threshold-based image-to-video aggregation, and GPS-integrated incident feature extraction constitutes a concrete technical improvement to traffic monitoring and incident detection technology. The improvement is not merely the application of an abstract idea of monitoring traffic or classifying images to a generic computing environment. Rather, the disclosed system provides specific technical solutions to specific technical problems inherent in prior art traffic monitoring systems, including the detection latency and coverage limitations of fixed-infrastructure sensor systems, the low-visibility performance degradation of visible-light camera systems, the drone-induced apparent vehicle movement artifacts that corrupt trajectory images in aerial monitoring systems, and the inability of prior art systems to simultaneously provide real-time incident detection, online visual verification, and congestion propagation monitoring from a mobile aerial platform. Each element of the claimed combination contributes a specific technical function that is integrated into a practical application of traffic incident detection technology, and the combination as a whole achieves technical results—including earlier incident detection, faster emergency response enablement, and real-time congestion propagation quantification—that are not achievable by any individual element of the combination or by prior art traffic monitoring systems. The disclosed system therefore represents an improvement to the functioning of traffic monitoring technology itself, rather than the use of traffic monitoring technology to implement an abstract idea.

In the foregoing specification, various examples have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings. The benefits, advantages, solutions to problems, and any element(s) that may cause any benefit, advantage, or solution to occur or become more pronounced are not to be construed as a critical, required, or essential features or elements of any or all the claims.

Moreover, in this document, relational terms such as first and second, top and bottom, and the like may be used to distinguish one entity or action from another entity or action without necessarily requiring or implying any actual such relationship or order between such entities or actions. The terms “comprises,” “comprising,” “has,” “having,” “includes,” “including,” “contains,” “containing,” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a,” “has . . . a,” “includes . . . a,” “contains . . . a” does not, without more constraints, preclude the existence of additional identical elements in the process, method, article, or apparatus that comprises, has, includes, contains the element. Unless the context of their usage unambiguously indicates otherwise, the articles “a,” “an,” and “the” should not be interpreted as meaning “one” or “only one.” Rather these articles should be interpreted as meaning “at least one” or “one or more.” Likewise, when the terms “the” or “said” are used to refer to a noun previously introduced by the indefinite article “a” or “an,” “the” and “said” mean “at least one” or “one or more” unless the usage unambiguously indicates otherwise.

The terms “approximately,” “about,” and “substantially” as used herein represent an amount close to the stated amount that is within standard manufacturing or process tolerances, or which still performs a desired function or achieves a desired result. For example, the terms “approximately,” “about,” and “substantially” may refer to an amount that is within less than 5% of, within less than 1% of, within less than 0.1% of, and within less than 0.01% of a stated amount. Further, it should be understood that any directions or reference frames in the preceding description are merely relative directions or movements. For example, any references to “up” and “down” or “above” or “below” are merely descriptive of the relative position or movement of the related elements.

Also, it should be understood that the illustrated components, unless explicitly described to the contrary, may be combined or divided into separate software, firmware, and/or hardware. For example, instead of being located within and performed by a single electronic processor, logic and processing described herein may be distributed among multiple electronic processors. Similarly, one or more memory modules and communication channels or networks may be used even if examples described or illustrated herein have a single such device or element. Also, regardless of how they are combined or divided, hardware and software components may be located on the same computing device or may be distributed among multiple different devices. Accordingly, in this description and in the claims, if an apparatus, method, or system is claimed, for example, as including a controller, control unit, electronic processor, computing device, logic element, module, memory module, communication channel or network, or other element configured in a certain manner, for example, to perform multiple functions, the claim or claim element should be interpreted as meaning one or more of such elements where any one of the one or more elements is configured as claimed, for example, to make any one or more of the recited multiple functions, such that the one or more elements, as a set, perform the multiple functions collectively.

It will be appreciated that some examples may be comprised of one or more generic or specialized processors (or “processing devices”) such as microprocessors, digital signal processors, customized processors and field programmable gate arrays (FPGAs) and unique stored program instructions (including both software and firmware) that control the one or more processors to implement, in conjunction with certain non-processor circuits, some, most, or all of the functions of the method and/or apparatus described herein. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used.

Moreover, an example can be implemented as a computer-readable storage medium having computer readable code stored thereon for programming a computer (e.g., comprising a processor) to perform a method as described and claimed herein. Any suitable computer-usable or computer readable medium may be utilized. Examples of such computer-readable storage mediums include, but are not limited to, a hard disk, a CD-ROM, an optical storage device, a magnetic storage device, a ROM (Read Only Memory), a PROM (Programmable Read Only Memory), an EPROM (Erasable Programmable Read Only Memory), an EEPROM (Electrically Erasable Programmable Read Only Memory) and a Flash memory. In the context of this document, a computer-usable or computer-readable medium may be any medium that can contain, store, communicate, propagate, or transport the program for use by or in connection with the instruction execution system, apparatus, or device.

A device or structure that is “configured” in a certain way is configured in at least that way, but may also be configured in ways that are not listed.

The terms “coupled,” “coupling” or “connected” as used herein can have several different meanings depending on the context in which these terms are used. For example, the terms coupled, coupling, or connected can have a mechanical or electrical connotation. For example, as used herein, the terms coupled, coupling, or connected can indicate that two elements or devices are directly connected to one another or connected to one another through intermediate elements or devices via an electrical element, electrical signal or a mechanical element depending on the particular context.

The Abstract is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various examples for the purpose of streamlining the disclosure. This method of disclosure is not to be interpreted as reflecting an intention that the claimed examples require more features than are expressly recited in each claim. Rather, as the following claims reflect, inventive subject matter lies in less than all features of a single disclosed example. Thus, the following claims are hereby incorporated into the Detailed Description, with each claim standing on its own as a separately claimed subject matter.

What is claimed is:

1. A traffic condition detection system comprising:
a processor; and
a non-transitory computer readable medium storing instructions executable to:
classify a traffic state represented in an input trajectory image as one of a plurality of traffic condition classes by performing, in each of a plurality of sequentially executed feature extraction stages, each stage receiving as an input either the input trajectory image for the first stage of the plurality of sequentially executed feature extraction stages, or a vector output by an immediately preceding stage:
apply a plurality of convolutional kernels having different spatial dimensions to the input to produce a plurality of feature maps, and combine the plurality of feature maps into a combined feature map;
generate a respective weight for each respective channel of the combined feature map by computing and passing through a learned transformation a respective global average value and a respective global maximum value, and scale each channel by the respective weight to produce a channel-weighted feature map;
generate a spatial weight map from the channel-weighted feature map by computing at each spatial location a respective summary value based on pooling across the channels, applying a convolution to the respective summary values to produce the spatial weight map, and multiplying the spatial weight map by the channel-weighted feature map to produce a spatially-weighted feature map; and
apply pooling operations at each of a plurality of different spatial resolutions to the spatially-weighted feature map and combine the resulting pooled values into a vector; and
pass the vector output by the last of the plurality of sequentially executed feature extraction stages through one or more fully connected layers to produce a traffic state classification.

2. The system of claim 1, wherein the input trajectory image is derived from aerial video data captured from an aerial perspective of a traffic environment.

3. The system of claim 2, wherein the aerial video data is captured by an unmanned aerial vehicle operating along a roadway corridor, and wherein the instructions are further executable to:
adjust coordinate sequences of detected vehicles represented in the aerial video data to compensate for displacement attributable to movement of the unmanned aerial vehicle during capture of the aerial video data, based on position data received from the unmanned aerial vehicle and timestamps of respective video frames.

4. The system of claim 2, wherein the aerial video data comprises thermal image data captured by a thermal imaging device.

5. The system of claim 1, wherein the instructions are further executable to:
prior to generation of the input trajectory image, discard vehicle detections having trajectories in a direction opposite to a predefined monitored traffic direction.

6. The system of claim 1, wherein combining the plurality of feature maps into the
combined feature map comprises:
concatenating the plurality of feature maps along a channel dimension and applying a 1×1 convolution to the concatenated feature maps to fuse the multi-scale feature representations.

7. The system of claim 1, wherein the input trajectory image comprises a color image having a plurality of color channels.

8. The system of claim 1, wherein the input trajectory image comprises a monochrome image having a single channel encoding grayscale intensity values.

9. The system of claim 1, wherein the instructions are further executable to:
apply a SoftMax activation function to an output of the one or more fully connected layers to produce a probability distribution over the plurality of traffic condition classes, and to assign, as the traffic state classification, a class having a highest probability in the probability distribution.

10. A process comprising:
classifying a traffic state represented in an input trajectory image as one of a plurality of traffic condition classes by performing, in each of a plurality of sequentially executed feature extraction stages, each stage receiving as an input either the input trajectory image for the first stage of the plurality of sequentially executed feature extraction stages, or a vector output by an immediately preceding stage:
applying a plurality of convolutional kernels having different spatial dimensions to the input to produce a plurality of feature maps;
combining the plurality of feature maps into a combined feature map;
generating a respective weight for each respective channel of the combined feature map; by computing and passing through a learned transformation a respective global average value and a respective global maximum value;
scaling each channel by the respective weight to produce a channel-weighted feature map;
generating a spatial weight map from the channel-weighted feature map by computing at each spatial location a respective summary value based on pooling across the channels, applying a convolution to the respective summary values to produce the spatial weight map, and multiplying the spatial weight map by the channel-weighted feature map to produce a spatially-weighted feature map; and
applying pooling operations at each of a plurality of different spatial resolutions to the spatially-weighted feature map and combine the resulting pooled values into a vector; and
passing the vector output by the last of the plurality of sequentially executed feature extraction stages through one or more fully connected layers to produce a traffic state classification.

11. The process of claim 10, wherein the plurality of traffic condition classes comprises normal traffic, recurrent congestion, and incident-induced non-recurrent congestion.

12. The process of claim 11, further comprising:
computing, for a video segment from which the input trajectory image is derived, a first ratio of trajectory images classified as indicating incident-induced non-recurrent congestion to a total number of trajectory images derived from the video segment;
computing a second ratio of trajectory images classified as indicating normal traffic to the total number of trajectory images;
classifying the video segment as capturing a traffic incident responsive to the first ratio exceeding a first predefined threshold; and
classifying the video segment as representing normal traffic conditions responsive to the first ratio being less than or equal to the first predefined threshold and the second ratio exceeding a second predefined threshold.

13. The process of claim 11, further comprising:
generating an alert indicating detection of a traffic incident responsive to classifying the traffic state as incident-induced non-recurrent congestion.

14. The process of claim 13, further comprising:
responsive to detecting the traffic incident, extracting a set of incident features comprising at least one of a time period of the incident, a congestion length associated with the incident, or a congestion propagation speed associated with the incident.

15. The process of claim 14, wherein extracting the time period of the incident comprises:
identifying, within a last video segment of a sequence of consecutively incident-classified video segments, a longest consecutive sequence of trajectory images classified as indicating incident-induced non-recurrent congestion; and
computing the time period of the incident as a time interval corresponding to the longest consecutive sequence.

16. The process of claim 14, wherein extracting the congestion length comprises:
receiving timestamped position data from an unmanned aerial vehicle at predefined intervals during a detection flight;
estimating, based on the timestamped position data and a duration of each video segment, a spatial range covered by each video segment; and
calculating the congestion length based on a cumulative spatial range spanned by a sequence of consecutively incident-classified video segments within the detection flight.

17. The process of claim 14, wherein extracting the congestion propagation speed comprises:
determining a change in congestion length between a first detection flight and a second detection flight of an unmanned aerial vehicle, each of the first and second detection flights associated with the detected traffic incident; and
computing the congestion propagation speed as a rate of change of the congestion length over a time interval between the first detection flight and the second detection flight.

18. The process of claim 13, further comprising:
outputting at least one signal to render, on a graphical user interface, a visualization map displaying geolocated incident detection results, wherein incident-induced non-recurrent congestion, recurrent congestion, and normal traffic conditions are represented by distinguishable markers on the visualization map, and
wherein the graphical user interface further displays a live video stream from an unmanned aerial vehicle and formatted detection results indicating the traffic state classification.

19. The process of claim 10, wherein the input trajectory image is derived from aerial video data captured by an unmanned aerial vehicle operating along a roadway corridor, and the process further comprises:
receiving, via a graphical user interface, an input to initiate a traffic incident detection session; and responsive to receiving the input, transmitting a control signal to initiate recording of a live video stream from the unmanned aerial vehicle and to initiate receiving of position data from the unmanned aerial vehicle.

20. A non-transitory computer readable medium storing instructions executable to:
classify a traffic state represented in an input trajectory image as one of a plurality of traffic condition classes by performing, in each of a plurality of sequentially executed feature extraction stages, each stage receiving as an input either the input trajectory image for the first stage of the plurality of sequentially executed feature extraction stages, or a vector output by an immediately preceding stage:
apply a plurality of convolutional kernels having different spatial dimensions to the input to produce a plurality of feature maps, and combine the plurality of feature maps into a combined feature map;
generate a respective weight for each respective channel of the combined feature map by computing and passing through a learned transformation a respective global average value and a respective global maximum value, and scale each channel by the respective weight to produce a channel-weighted feature map;
generate a spatial weight map from the channel-weighted feature map by computing at each spatial location a respective summary value based on pooling across the channels, applying a convolution to the respective summary values to produce the spatial weight map, and multiplying the spatial weight map by the channel-weighted feature map to produce a spatially-weighted feature map; and
apply pooling operations at each of a plurality of different spatial resolutions to the spatially-weighted feature map and combine the resulting pooled values into a vector; and
pass the vector output by the last of the plurality of sequentially executed feature extraction stages through one or more fully connected layers to produce a traffic state classification.
